(19) United States
(12) Patent Application Publication
(10) Pub. No.: US 2011/0027547 A1
(43) Pub. Date: Feb. 3, 2011

(54) Methods of making reactive composite materials and resulting products

(75) Inventors: Yuwei Xun, Cockeyville, MD (US); David Lunking, Columbia, MD (US); Etienne Besnoin, Baltimore, MD (US); David Van Heerden, Baltimore, MD (US); Timothy P. Weihs, Baltimore, MD (US); Omar Knio, Timonium, MD (US)

Correspondence Address: Polster, Lieder, Woodruff & Lucchesi, L.C., 12412 Powerscourt Dr. Suite 200, St. Louis, MO, 63131-3615, US

(73) Assignee: Reactive Nanotechnologies, Inc.

(21) Appl. No.: 11/471,779

(22) Filed: Jun. 21, 2006

Related U.S. Application Data
(63) Continuation-in-part of application No. 10/814,243, filed on Apr. 1, 2004, now Pat. No. 7,121,402.
Application No. 10/814,243 is a continuation-in-part of application No. 10/959,502, filed on Oct. 7, 2004, now abandoned.
Application No. 10/959,502 is a continuation-in-part of application No. 10/976,877, filed on Nov. 1, 2004, now Pat. No. 7,441,688.
Application No. 10/976,877 is a continuation-in-part of application No. 10/843,352, filed on May 12, 2004, now abandoned.
Application No. 10/843,352 is a continuation-in-part of application No. 10/844,816, filed on May 13, 2004, now Pat. No. 7,361,412.
Application No. 10/844,816 is a continuation-in-part of application No. 10/761,688, filed on Jan. 21, 2004, now abandoned.
Application No. 10/761,688 is a division of application No. 09/846,486, filed on May 1, 2001, now Pat. No. 6,736,942.
Application No. 10/976,877 is a continuation-in-part of application No. 10/898,650, filed on Jul. 23, 2004, now abandoned.
Application No. 10/898,650 is a continuation-in-part of application No. 10/844,816, filed on May 13, 2004, now Pat. No. 7,361,412.
Application No. 10/898,650 is a continuation-in-part of application No. 10/761,688, filed on Jan. 21, 2004, now abandoned.
Application No. 10/761,688 is a division of application No. 09/846,486, filed on May 1, 2001, now Pat. No. 6,736,942.
(60) Provisional application No. 60/692,822, filed on Jun. 22, 2005.
(60) Provisional application No. 60/461,196, filed on Apr. 9, 2003.
(60) Provisional application No. 60/509,526, filed on Oct. 9, 2003.
(60) Provisional application No. 60/516,755, filed on Nov. 4, 2003.
(60) Provisional application No. 60/469,841, filed on May 13, 2003.
(60) Provisional application No. 60/469,841, filed on May 13, 2003.
(60) Provisional application No. 60/475,830, filed on Jun. 4, 2003.
(60) Provisional application No. 60/201,292, filed on May 2, 2000.
(60) Provisional application No. 60/489,378, filed on Jul. 23, 2003.
(60) Provisional application No. 60/469,841, filed on May 13, 2003.
(60) Provisional application No. 60/475,830, filed on Jun. 4, 2003.
(60) Provisional application No. 60/201,292, filed on May 2, 2000.

(51) Int. Cl. B32B 3/10; C21D 8/00; C06B 45/12; C06B 45/16; B21D 31/00; B21H 1/22

(52) U.S. Cl. 428/201; 148/516; 149/14; 149/16; 72/379.2; 72/199

(57) ABSTRACT

Applicants have discovered new composite materials and have developed a variety of new ways of making reactive composite materials (RCMs) and methods of controlling the properties and characteristics of the materials that are pertinent to numerous new or improved applications. This patent application is directed to new and improved ways of making reactive composite materials using mechanical deformation and making such materials with controlled, predictable characteristics. This application is also directed toward useful applications of the resulting materials.

In accordance with the invention, RCMs are fabricated by a series of mechanical deformation steps. In the first deformation step, an assembly of reactive layers and/or particles is plastically deformed to reduce its cross sectional area by one-half or more. This severe initial deformation substantially eliminates the tendency of deformed layers to delaminate and eliminates the necessity of using specially cleaned metal layers. Portions of the deformed sheets are stacked or bent into a new assembly, and the new assembly is then deformed. The steps of assembly and deformation are repeated a sufficient number of times that the resulting materials are only locally layered but have relatively uniform reaction velocity and heat generating characteristics predictable by stochastic models derived herein. The resulting product is a controllable, locally layered reactive composite material (LLRCM) that can be fabricated quickly and is useful in a wide variety of applications.

### CROSS-REFERENCE TO RELATED APPLICATIONS

This application claims the benefit of U.S. Provisional Application Ser. No. 60/692,822 filed by T. P. Weihs, et al., on Jun. 22, 2005.

This application is also a continuation-in-part of U.S. application Ser. No. 10/814,243 filed by T. P. Weihs et al. on Apr. 1, 2004 (“Hermetically Sealed Product and Related Methods of Manufacture”) which, in turn, claims the benefit of Ser. No. 60/461,196 filed Apr. 9, 2003.

This application is further a continuation-in-part of U.S. application Ser. No. 10/959,502 filed by T. P. Weihs et al. on Oct. 7, 2004 (“Methods of Controlling Multilayer Foil Ignition”) which claims the benefit of Ser. No. 60/509,526 filed Oct. 9, 2003.

This application is also a continuation-in-part of U.S. application Ser. No. 10/976,877 filed by T. P. Weihs et al. on Nov. 1, 2004 (“Methods and Device for Controlling Pressure in Reactive Multilayer Joining and Resulting Product”) which, in turn, claims the benefit of 60/516,775 filed Nov. 4, 2003.

And this application is further a continuation-in-part of U.S. application Ser. No. 10/843,352 (“Method of Controlling Thermal Waves in Reactive Multilayer Joining and Resulting Product”) filed May 12, 2004 which claims the benefit of 60/469,841 filed May 13, 2003. Each of the aforementioned '243, '196, '502, '526, '877, '775, '352 and '841 applications is incorporated herein by reference.

This application is also a continuation-in-part of U.S. application Ser. No. 10/844,816 filed by Jiaping Wang et al. on May 13, 2004 (“Nanostructured Soldered or Brazed Joints Made with Reactive Multilayer Foils”) which claims the benefit of U.S. Provisional Application Ser. No. 60/469,841 filed by Etienne Besnoin et al. on May 13, 2003 (“Method of Controlling Thermal Waves in Reactive Multilayer Joining and Resulting Product”) and Provisional Application Ser. No. 60/475,830 filed by Jiaping Wang et al. on Jun. 4, 2003 (“Microstructure of Solder or Braze in Joints Made with Freestanding Reactive Multilayer Foils”). Ser. No. 10/844,816 is also a continuation-in-part of application Ser. No. 10/761,688 filed by T. Weihs et al. on Jan. 21, 2004 as a divisional of application Ser. No. 09/846,486 filed by T. Weihs et al. on May 1, 2001 (“Freestanding Reactive Multilayer Foils”); that claims the benefit of Provisional Application Ser. No. 60/201,292 filed by T. Weihs et al. on May 2, 2000 (“Reactive Multilayer Foils”). All of the applications cited in this paragraph and section are incorporated herein by reference.

This application is also a continuation-in-part of U.S. application Ser. No. 10/898,650 filed by Jiaping Wang et al. et al. on Jul. 23, 2004 (“Method of Joining Using Reactive Multilayer Foils with Enhanced Control of Molten Joining Materials”) which claims the benefit of U.S. Provisional application Ser. No. 60/489,378 filed by Jiaping Wang et al. on Jul. 23, 2003 (“Methodology of Controlling Flow of Molten Solder or Braze in Reactive Multilayer Joining”). Ser. No. 10/898,650 is also a continuation-in-part of U.S. application Ser. No. 10/844,816 (previously identified) which claims the benefit of two previously identified provisional applications (Ser. No. 60/469,841 and 60/475,830). Ser. No. 10/898,650 is also a continuation-in-part of Ser. No. 10/761,688 (previously identified) which is a divisional of Ser. No. 09/846,486 (previously identified) that claims the benefit of Ser. No. 60/201,292 (previously identified). All of the applications cited in this paragraph and section are incorporated herein by reference.

### GOVERNMENT INTEREST

The United States Government has certain rights in this invention pursuant to Award 70NANB3H3045 supported by NIST.

### FIELD OF THE INVENTION

This invention relates to locally layered reactive composite materials, and, in particular, to a method of making such composite materials using mechanical deformation. It also concerns the resulting products and their applications.

### BACKGROUND OF THE INVENTION

Reactive composite materials (“RCMs”) are useful in a wide variety of applications requiring the generation of intense, controlled amounts of heat in a localized region. Reactive composite materials typically comprise two or more phases of materials, spaced in a controlled fashion throughout the composite in uniform or non-uniform layers, islands, or particles that, upon appropriate excitation, undergo an exothermic chemical reaction that spreads through the composite material generating heat and light. Important applications include: (a) reactive multilayer joining (see, for example, U.S. patent application Ser. No. 10/843,352 filed May 12, 2004 which is incorporated herein by reference); (b) hermetic sealing (see, for example, U.S. patent application Ser. No. 10/814,243 filed Apr. 1, 2004, incorporated herein by reference); (c) structural elements that are capable of releasing energy (examples of which are disclosed in U.S. Provisional Patent 60/692,857 and U.S. Provisional Patent 60/740,115); and (d) initiating secondary reactions, as in flares, detonators and propellant-based devices. This application describes methods of making a type of RCM that will be referred to as a locally layered RCM.

RCMs may be produced via vapor deposition, mechanical deformation, or electrodeposition. Some methods of making and using RCMs are disclosed in the U.S. Pat. No. 6,736,942 entitled “Freestanding Reactive Multilayer Foils” (“the '942 patent”); incorporated herein by reference as well as in the U.S. Pat. No. 6,534,194 entitled “Method of Making Reactive Multilayer Foil and Resulting Product” (“the '194 patent”); incorporated herein by reference.

Self-propagating reactions in RCMs are driven by a reduction in chemical bond energy. Upon the application of a suitable stimulus to ignite, a local bond exchange between constituents of the RCM produces heat that is conducted through the RCM to drive the reaction. Recent developments in RCM technology have shown that it is possible to carefully control the ignition threshold and the heat and velocity of the reaction. For instance, it has been demonstrated that the velocities, heats, and/or temperatures of the reactions in an RCM can be controlled by varying the thicknesses of the alternating layers or sizes of the reactant regions, and that the heats of reaction can be controlled by modifying the RCM composition or by low-temperature annealing of the RCM after fabrication.

In addition to vapor deposition, efforts were previously made to develop freestanding reactive multilayer materials by cold rolling. See L. Battezzatti et al., Acta Materialia, Vol. 47, pp. 1901-1914 (1999)⁸. Ni—Al multilayer reactive foils were formed by cold-rolling bilayer sheets of Ni and Al, followed by repeated manual folding and repeated cold rolling. After the first bilayer strip was rolled to half its original thickness, it was folded once to regain its original thickness and to double the number of layers. This process was repeated many times.

This fabrication of the rolled foils was time consuming and difficult. The rolling passes required lubricating oil, and the surfaces of the rolled materials were cleaned after every pass. In addition, the manual folding of sheet stock does not easily lend itself to large-scale production. Starting with a stack of metallic sheets and then rolling and folding a few times would simplify the process. However, when many metal layers are rolled at once, these layers tend to delaminate, causing degradation of the resulting foil. Such separation also permits undesirable oxidation of interlayer surfaces and impedes unification of the layers by cold welding.

Moreover repeated rolling passes tended to distort the layered structures in ways not then predictable, producing necking, elongation or rupture in individual layers, changing the relative thicknesses of the layers, decreasing the ductility of the resulting foil and, significantly, preventing the fabrication of a foil with prescribed reaction velocity and heat generating characteristics.

A high degree of control of reaction velocity and heat generation can now be achieved in uniformly layered foils made by physical vapor deposition. However, because physical vapor deposition builds foils atom by atom or molecule by molecule, it is not well-suited to the formation of thick layers and thick foils.

Accordingly there is a need for improved methods of fabricating reactive composite materials and the resulting products, especially those with selectable or controllable reaction properties.

### SUMMARY OF THE INVENTION

Applicants have discovered new composite materials and have developed a variety of new ways of making reactive composite materials (RCMs) and methods of controlling the properties and characteristics of the materials that are pertinent to numerous new or improved applications. This patent application is directed to new and improved ways of making reactive composite materials using mechanical deformation and making such materials with controlled, predictable characteristics. This application is also directed toward useful applications of the resulting materials.

In accordance with the invention, RCMs are fabricated by a series of mechanical deformation steps. In the first deformation step, an assembly of reactive layers and/or particles is plastically deformed to reduce its cross sectional area by one-half or more. This severe initial deformation substantially eliminates the tendency of deformed layers to delaminate and eliminates the necessity of using specially cleaned metal layers. Portions of the deformed sheets are stacked or bent into a new assembly, and the new assembly is then deformed. The steps of assembly and deformation are repeated a sufficient number of times that the resulting materials are only locally layered but have relatively uniform reaction velocity and heat generating characteristics predictable by stochastic models derived herein. The resulting product is a controllable, locally layered reactive composite material (LLRCM) that can be fabricated quickly and is useful in a wide variety of applications.

### BRIEF DESCRIPTION OF THE DRAWINGS

The nature, advantages and various additional features of the invention will appear more fully upon consideration of the illustrative embodiments now to be described in detail in connection with the accompanying drawings. In the drawings:

FIG. 1 is a schematic illustration of the cold rolling of a multilayer stack.

FIG. 2 is a schematic illustration of the mechanical formation processes (a) process comprising rolling, cutting and stacking steps, and (b) process comprising rolling and stacking steps.

FIG. 3 is a SEM micrograph of an exemplary Pd/Al multilayer stack after 50% reduction (1 pass). The darker layers are Aluminum, the lighter layers are Palladium.

FIG. 4 is a SEM micrograph of an exemplary Ni/Al multilayer reactive foil after 33 passes. The lighter layers are nickel, the darker layers aluminum.

FIG. 5 schematically illustrates a metal foil/powder assembly prior to rolling.

FIG. 6 is a schematic illustration of an oxidized Cu foil prior to rolling.

FIG. 7 is an SEM micrograph of an exemplary Al/CuOx multilayer after 75% reduction. Prior to rolling, the initial assembly is as illustrated in FIG. 5.

FIG. 8 is an SEM micrograph of an exemplary Al/CuOx multilayer after 8 passes.

FIG. 9 plots measured bilayer frequency versus measured bilayer thickness for Pd/Al foils after 4, 6 and 8 passes.

FIG. 10 graphs measured bilayer frequency versus measured bilayer thickness for Pd/Al foils after 12, 16, 18 and 20 passes.

FIG. 11 plots measured mean bilayer thickness versus number of passes for Pd/Al foil. Diamonds for numerical mean, squares for weighted mean.

FIG. 12 is an optical photograph of washer-shaped components punched from cold rolled reactive Ni/Al foil.

FIG. 13 plots measured reaction energy versus number of passes for as-rolled (diamonds) and annealed (squares and triangles) Pd/Al foils. The foils were annealed in nitrogen for 24 or 48 hours at 125° C. as indicated.

FIG. 14 graphs measured reaction energy versus weighted mean bilayer thickness for as-rolled (diamonds) and annealed (squares and triangles) Pd/Al foils. The foils were annealed in nitrogen for 24 or 48 hours at 125° C. as indicated.

FIG. 15 shows peak temperature shift as a function of heating rate in cold rolled Pd/Al samples: n=12.36 and 550 nm weighted mean bilayer thickness. Graph of [natural log(heating rate/peak temperature²)] vs. [1/(Peak temperature*k_{b})]. Slope of the linear fit lines is the activation energy of the individual reactions. The overall activation energy reported is the flattest slope.

FIG. 16 plots measured reaction velocity versus number of passes for as-rolled (diamonds) and annealed (squares and triangles) Pd/Al foils.

FIG. 17 graphs measured reaction velocity versus mean bilayer thickness for as-rolled (diamonds and squares) and annealed (triangles and crosses) Pd/Al foils.

FIG. 18 illustrates probability density functions (PDFs) of the measured bilayer frequency versus measured bilayer thickness, for Pd/Al foils after 16 passes. Each PDF corresponds to a particular choice of number of bins.

FIG. 19 shows the dependence of the predicted average reaction front speed on (a) the number of bins used to model the PDF of the bilayer thickness and (b) the width of these bins, for Pd/Al foils after 8 and 16 passes.

FIG. 20 shows the dependence of the predicted average reaction front velocity on the atomic diffusivity pre-exponent of cold rolled Pd/Al foils. Predictions were obtained for foils after four passes. The measured reaction velocity is also shown for comparison (dashed line).

FIG. 21 illustrates the variation of the theoretical amount of intermixing in as-rolled foils with number of passes, computed using DSC measurements of the foil heat of reaction.

FIG. 22 illustrates the predicted evolution of the reaction front position in various regions across the foil. The curves show a) the position of the front in all the bilayers of an as-rolled Pd/Al foil after 8 passes (circles), and b) the simultaneous position of the front in the thinnest bilayers (full line, no symbol) and thickest bilayers (dashed line) of an as-rolled Pd/Al foil after 20 passes and after 24 hour anneal at 125° C. The front position in each layer is defined as the position of the maximal total power. The predictions were obtained using Model 1.

FIG. 23 shows the predicted evolution of the instantaneous reaction front speed in various regions across the foil. The curves show a) the front speed in all the bilayers of an as-rolled Pd/Al foil after 8 passes (circles), and b) the simultaneous front speed in the thinnest bilayers (full line, no symbol) and thickest bilayers (dashed line) of an as-rolled Pd/Al foil after 20 passes and after 24 hour anneal at 125° C. The instantaneous front speed in each layer is defined as the derivative of the position of the maximal total power versus time. The predictions were obtained using Model 1.

FIG. 24 shows the variation of the computed (dashed lines) and measured (full line) reaction velocity in as-rolled Pd/Al foils with number of passes. Predictions were obtained assuming that the amount of intermixing at the interface between two consecutive layers of reactant is the same for all interfaces (Model 1) and that the amount of intermixing between two layers of reactant is proportional to the thickness of these two layers (Model 2).

FIG. 25 illustrates the dependence of the computed (dashed lines) and measured (full line) reaction velocity in as-rolled Pd/Al foils on weighted bilayer thickness.

FIG. 26 shows the dependence of the reaction velocity in as-rolled Pd/Al foils on weighted bilayer thickness, obtained using the stochastic model (dashed lines) and the single mean-bilayer model (full line). Predictions of the former are obtained assuming that the amount of intermixing at the interface between two consecutive layers of reactant is uniform for all interfaces (Model 1) and by assuming that the ratio 2wᵢ/δᵢ is constant for all the bilayers (Model 2).

FIG. 27 graphically illustrates the variation of the computed (open symbols) and measured (closed line and symbols) reaction velocity with the number of passes in cold-rolled Pd/Al foils that were annealed for 24 hours at 125° C.

FIG. 28 presents the predicted dependence of the reaction velocity in cold-rolled Pd/Al foils on weighted bilayer thickness. Each curve corresponds to a constant intermixing thickness of 100 nm (circles), 50 nm (diamonds) and 0 nm (squares).

FIG. 29 presents the dependence of the measured (full line) and computed (dashed line) reaction velocity in as-rolled Pd/Al foils on weighted bilayer thickness. The computed values are derived from Eq. 28, and are obtained using K=24×10⁻⁶ m²/s, p=3 and q=1.4.

FIG. 30 is a schematic block diagram showing the steps involved in making a reactive composite material.

FIG. 31 is an SEM micrograph of an exemplary Al/NiO composite reactive foil after 11 rolling passes illustrating the distributed particulate structure;

FIG. 32 is a schematic block diagram showing the steps of a first approach to making reactive composite wires or rods;

FIG. 33 is a photomicrograph depicting in two different magnifications a cross section of a NiO/Al reactive composite wire made by the process of FIG. 32;

FIG. 34 is a photomicrograph depicting the cross section of a Ni/Al reactive composite wire made by the process of FIG. 32;

FIG. 35 is a schematic block diagram of an alternative approach to making reactive composite wires or rods;

FIG. 36 is an SEM micrograph of a cross section of an exemplary Ni/Al reactive composite foil after one pass and illustrating the island structure;

FIG. 37 is an SEM micrograph of a cross-section of an exemplary Ni/Al reactive composite foil after 18 passes and illustrating the short non-uniformly layered structure;

FIG. 38 is an SEM micrograph of an exemplary Ni/Al reactive composite foil after 20 passes, illustrating the long non-uniformly layered structure as well as shear bands that are about 30 degrees above and below the plane of the rolling direction;

FIG. 39 presents X-ray diffraction traces for cold rolled Ni/Al reactive composite foils at different stages of mechanical deformation as well as the trace for a sputter deposited Ni/Al reactive foil;

FIG. 40 is a plot of bilayer thickness vs. pass number for Pd/Al LLRCMs with two different hardness ratios; and

FIG. 41 is a plot of reaction velocity vs. pass number for two Pd/Al LLRCMs with different hardness ratios.

It is understood that these drawings are for purposes of illustrating the concepts of the invention and, except for graphs and photographs, are not to scale.

### DETAILED DESCRIPTION OF THE INVENTION

This description is divided into two parts: Part I describes reactive composite materials and their fabrication in accordance with the invention; and Part II describes the beneficial features and characteristics of the resulting products in relation to fabrication parameters.

I. Methods of Fabricating Reactive Composite Materials

Recent developments in reactive multilayer technology have shown that it is possible to carefully control both the heat of the reaction as well as the reaction velocity, and have also provided alternative means for fabricating nanostructured multilayers. For instance, it has been demonstrated that the velocities, heats, and temperatures of the reactions can be controlled in uniformly layered RCMs by varying the thicknesses of the alternating layers^{1,2}. It has also been shown that the heats of reaction can be controlled by modifying the multilayer composition, or by low-temperature annealing of the reactive multilayers after their fabrication³.

The same chemical reactions used in RCMs may be produced using powders. When reactive powders are used, a mixture of discrete particles of metals or compounds that will react exothermically in a self-propagating reaction to form a final compound or an alloy is utilized. Such processes have existed since self-propagating powders were developed in the early 1960s, spawning what is known as self-propagating, high-temperature synthesis (SHS). However, unlike reactive multilayers, particle mixtures are discontinuous, and consequently, the reaction behavior of reactive powder mixtures is heavily influenced by powder morphology and mixing technique, making reproducible results difficult to obtain.

In both RCMs and SHS, the reaction is driven by a reduction in bond energy. Two major classes of chemical reaction have been utilized: (a) formation reactions and (b) reduction-oxidation or thermite reactions. In formation reactions, a compound AB is formed as a result of mixing of two chemicals A and B, and during the reaction A-A and B-B bonds are exchanged for AB bonds. Well-known systems include aluminide, carbide, boride and silicide formation reactions. Thermite reactions typically involve interactions between a metal oxide and a metallic element, selected such that during the reaction the original metal oxide is reduced while the metallic element is oxidized. Well known examples include interactions between iron oxide and aluminum, and copper oxide and aluminum. Multiple reactions may be incorporated into one RCM.

Alternative methods for fabricating RCMs include vapor deposition, electrochemical deposition and mechanical processing. Compared with vapor deposition and electrochemical deposition, mechanical processing offers the promise of fabricating RCMs at a significantly lower cost, and consequently the possibility of reaching wider market applications. As further discussed below, this processing approach is the focus of the present invention.

In the mechanical formation approach, a stack of foils alternating between at least two materials with large negative heats of mixing is initially assembled. The initial thickness of individual foils within the stack typically ranges from 5 to 200 μm. In order to obtain a nanoscale multilayered structure, the stack is then processed by severe plastic deformation, which usually involves a total strain, ε, higher than 7. For example, RCMs having 30 nm-thick nickel layers were observed after repeated folding and cold rolling bilayer stack of nickel and aluminum foils (initially 7.5 to 50 μm in thickness) for 70 processing cycles (ε=48.5)⁴. Efforts were also made to develop nanostructured foils by swaging a jacketed multilayer assembly and flattening the swaged jacket into a sheet by cold rolling. Alternating layers with thickness varying from 300 nm to 2 μm were thus obtained, and the resulting multilayered structure exhibited large heat release upon ignition.⁵ Other mechanical techniques employed for forming RCMs include extrusion-rolling⁶, press-rolling⁷ and sheath-rolling^{7,8}.

A careful investigation of previous work^{4,6,7,8,9,10,11,12,13,14,15} reveals some commonly observed trends and associated problems in mechanically-formed multilayers:
Necking, elongation or rupture may occur in individual layers during deformation, depending on hardness and plasticity compliance between elemental sheets. Necked and elongated layers usually show uniform thinning while ruptured phases may result in particle-shaped regions instead of a layered structure. A general understanding of how the material responds during rolling is lacking; consequently, it is difficult to quantitatively predict the microstructure of mechanically-formed multilayers, or to characterize their microstructure as function of process parameters. One aspect of this invention is to introduce a mechanical formation process where process parameters are well correlated with the microstructural properties of the resulting product.
The thicknesses of individual layers decrease with higher degree of deformation. The rate of layer refinement is primarily controlled by the deformation (yielding and fracturing) of the harder elemental material. During early stages of rolling, the deformation of the hard phase occurs primarily due to fracture rather than elongation. The soft phase transmits the load to the hard phase and fills up the space between fractured hard phase filaments. With further rolling, higher stresses are needed to fracture the hard phase; consequently the hard phase starts to elongate, resulting in thinner layers. Although it has been observed that the rates of layer refinement vary in different materials systems, little is known about the effect of material parameters (e.g. hardness ratio between elemental phases) on this variation. As further discussed below, another aspect of this invention is to provide criteria for process selection as function of material parameters. This is of practical significance since the layer refinement rate determines the production rate of rolling.
Mechanically formed multilayers are in most cases characterized by a distribution of layers having different thicknesses. In particular, there is considerable variation in the local thickness of the layers, especially since plastic deformation is inherently unevenly distributed in elemental materials. This microstructural characteristic distinguishes most cold rolled multilayers from sputter-deposited multilayers in which the layering is uniform and the layer width is accordingly well-defined. The non-uniform layering within mechanically-formed multilayers poses a significant challenge to characterizing the properties of the corresponding reactions, since the dependence of the reaction properties on the non-uniform layering is as of yet unknown. Another aspect of this invention is to introduce mechanically-formed reactive multilayer materials having a selectable propagation velocity, together with a phenomenological model that captures the dependence of the reaction velocity on the non-uniform layering of the same materials.
The flow stress increases and the ductility decreases in rolled foils as the layer thicknesses become smaller. Both structure refinement and work hardening contribute to the increased flow stress as rolling proceeds. After a large degree of plastic deformation, the ductility of the starting materials is exhausted and the foil becomes brittle. This embrittlement generally leads to severe limitations on large-scale or mass production of multilayer structures. Due in large part to the fact that most efforts have focused on laboratory-scale, small-sized samples, means to overcome embrittlement limitations are lacking. Another aspect of the invention is to provide a suitable approach to overcome embrittlement, and thus enable large-scale, cost-effective mechanical formation of multilayer structures.
The volume fraction of the intermixed zone is a key property of the multilayer structure; this is because intermixing directly affects the amount of heat that is released by the self-propagating reaction and consequently key reaction properties such as velocity and temperature. Deformation-induced mixing generally varies with strain. Higher strain results in larger deformation-induced mixing at the interface between otherwise chemically distinct layers, as well as increased interface area due to layer refinement. Available results on deformation-induced mixing are quite limited, and insufficient to determine how intermixing evolves as a function of strain and strain rate. An aspect of the invention is to provide mechanically-formed reactive composites having selectable propagation velocity and deformation-induced mixing determined by parameters of the fabrication process.

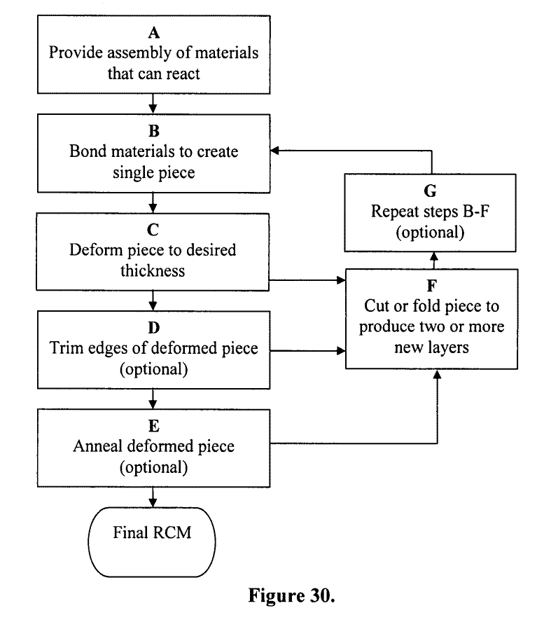

Referring to the drawings, FIG. 30 is a schematic flow diagram illustrating the basic steps involved in fabricating a locally layered reactive composite material having selectable reaction velocity and heat generating characteristics. The first step, shown in Block A of FIG. 30, is to provide an assembly (a stack or a multilayer) of alternating layers of materials that can exothermically react. The term “stack” as used herein refers to an assembly of unbonded layers. The term “locally layered reactive composite material” (“LLRCM”), as used herein, refers to an assembly of local layers, islands or particles that have been joined together as a continuous structure, as by plastic deformation. The assembly can comprise alternating local layers of metals or alloys. It can also comprise alternating local layers and particle layers joined together in a continuous structure. It does not include uniformly layered multilayer structures as made by physical vapor deposition nor does it include RCMs composed solely of discrete particles. The reactive layers or particles can also be separated by appropriately thin diluting material to slow down the reaction. Advantageously the initial assembly is a stack of individual layers as opposed to folded layers. It is also preferred that the initial stack avoid the use of sheath layers to hold the reactive layers.

The next step (Block B) is to bond the assembly to produce a single LLRCM piece, preferably by rolling. Applicants have found that with sufficient deformation on the first rolling step, a stacked assembly of alternating sheets can be sufficiently welded together by the deformation to minimize subsequent delamination problems. Typically this requires sufficient deformation to reduce the cross-sectional area by one-half or more. The preferred method of deformation is cold rolling at a strain rate ranging between 10⁻² and 1 s⁻¹. The preferred rolling temperature is 100° C. or less. This approach, followed by repeated similar rolling steps (block C) develops LLRCM composite structures with predictable properties. Alternatively, the deformation can be effected by sheath rolling, swaging, extrusion or hot pressing.

After the deformation, as shown in Block D, one can optionally trim the edges of the deformed sheet to reduce the possibility of cracking from the edge. Such trimming is preferred.

The deformed sheet can also be optionally annealed, as in an inert atmosphere, to modulate the heat generating characteristics of the ultimate finished product or to improve the rolling characteristics of the multilayer piece (Block E). Annealing is preferably at a temperature of about 150° C. or less.

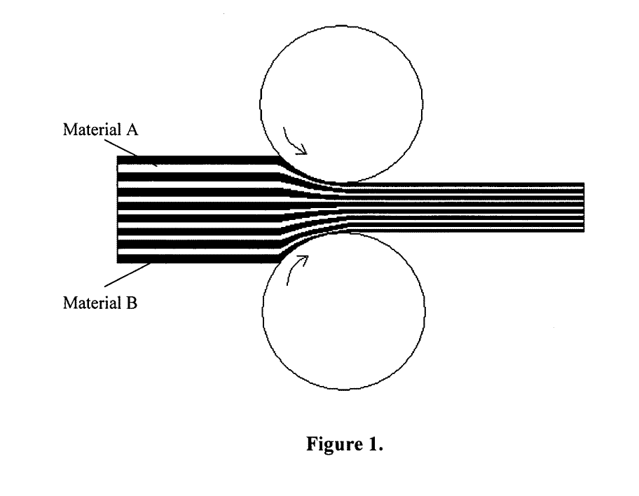

The next step, shown in Block F, is to divide the deformed sheet, as by cutting, into two or more deformed layers, which are then stacked and bonded as in block B. The process repeats until the desired microstructure, material properties, and reaction properties as described below are achieved. FIG. 1 illustrates an exemplary rolling step starting from a stack of layers that alternate between materials A and B that can exothermically react. For example the stack can be alternating layers of palladium and aluminum.

Alternatively, the initial configuration can be obtained by stacking foils or sheets that are individually coated with a powder or particle layer comprising a second material that reacts exothermically with constituents of the foils or sheets. An example illustrating this second initial configuration consists of aluminum foil coated with a fine layer of copper oxide particles, shown schematically in FIG. 5. As discussed earlier, the reactive materials present in the alternating layers can be selected from a number of reactive pairs, including those appearing in energetic aluminide, silicide, boride, and carbide formation reactions, as well as thermite reactions. One repeating unit of reactants, for instance one nickel sheet and one aluminum sheet, or one aluminum sheet with one layer of copper oxide on it, or one aluminum sheet and one oxidized copper sheet, is hereinafter considered a “bilayer”.

In one embodiment, the initial stack is formed using commercially available metal or alloy foils, in as-received condition without additional cleaning and/or heat treatment. This is a useful advantage since cleaning steps and heat treatment involve considerable processing time and cost.

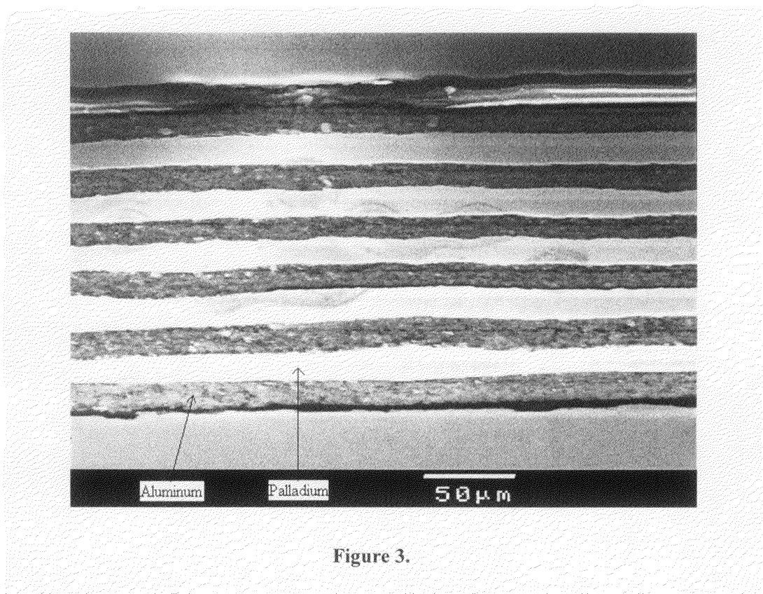

In another embodiment of this invention, the initial stack (block A in FIG. 30) consists of two or more bilayers of materials that react exothermically. However, a larger number of bilayers is preferable since fewer stacking and rolling steps are required to achieve a certain number of total bilayers. For material systems requiring less refinement to achieve self-propagating reaction, such as Pd/Al, an initial stack comprising five to ten bilayers is sufficient to ensure high quality reactive foil after four or more rolling passes (FIG. 3). In contrast, for Ni/Al multilayers, a larger number of passes (18 or more) is required to obtain a self-propagating front. In these situations, it is helpful to use an initial stack comprising 20 or more bilayers in order to reduce total processing time. Generally, a stack consisting of five or more bilayers is a reasonable starting point for most material systems.

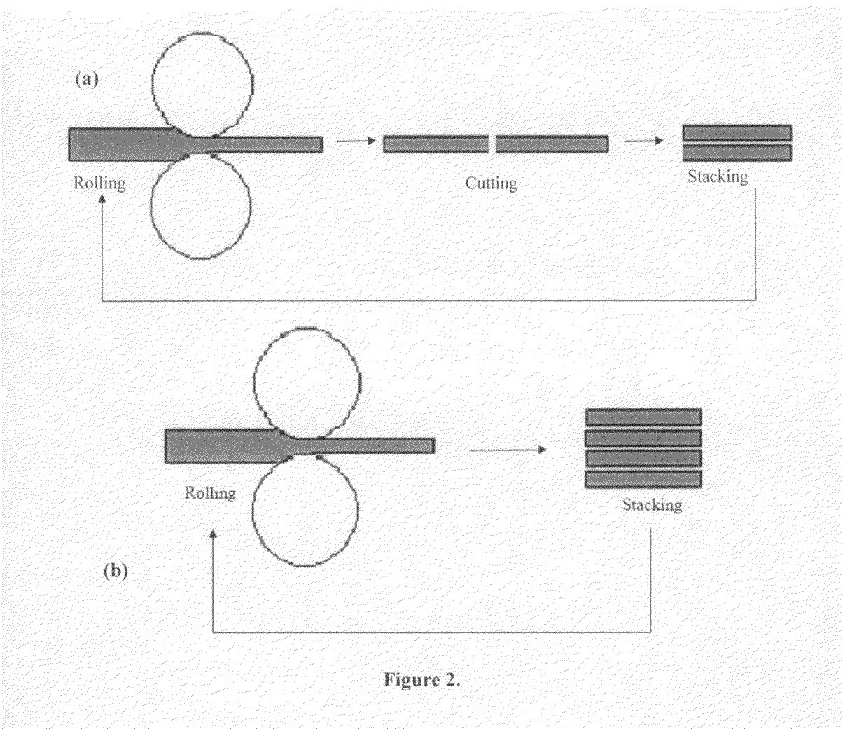

In another embodiment, the initial stack is processed by cold rolling in order to reduce the bilayer thickness (FIGS. 1 and 2, blocks B and C in FIG. 30). As used in this invention, “rolling step” refers to the single operation of feeding a stack or a multilayer material through a rolling mill. Meanwhile, “rolling pass” refers to a 50% reduction in thickness of a stack or a multilayer material using one or more successive rolling steps. At early stages in the formation process, a rolling pass may be achieved using a single rolling step, but multiple rolling steps may be needed to achieve a rolling pass at later stages as the material becomes stronger with increasing deformation due to work hardening. After each rolling pass, the foil may be cut and re-stacked for the next rolling pass (FIG. 2a, block E in FIG. 30). Alternatively, two or more pieces of multilayer material can be assembled to form a stack that is subjected to further rolling steps (FIG. 2b).

Deformation uniformity is enhanced and edge defects are reduced by carefully aligning individual foils or layers when preparing the stack. It is necessary that foils in the stack be adhered in one single rolling step to avoid further aligning and stacking of the un-bonded stack. Misalignment may cause delamination in rolled foil.

There are two types of cracking in rolled foils. Edge cracking, which is commonly encountered in most rolling processes, starts in the early stages of rolling. As discussed above, cracked edges may be trimmed away every several steps to impede the propagation of crack from edge to center. For materials requiring many rolling steps and several edge-trimmings, a wider starting sample is needed to produce more finished material. In particular, a starting stack geometry with width/thickness ratio larger than about 200:1 is required in order to minimize material loss due to edge cracking. Another type of cracking may begin to develop in the bulk of the hardened and fragile specimen after a high degree of deformation. For example, after 28 rolling passes in a Ni/Al multilayer, microscale cracking occurs in the bulk of the sample. These microcracks not only make foil cutting and stacking difficult, but also cause the reaction properties of the foil to deteriorate. Low temperature annealing plus large thickness reduction in a single rolling step may reduce and heal these microcracks.

In another embodiment of the invention, edge cracking is effectively controlled by trimming or shearing cracked edges following several rolling steps. Edge cracking is also controlled by maintaining a relatively low rolling speed during rolling steps. Generally speaking, a strain rate of 10⁻² to 1 s⁻¹ is sufficient for cracking control. Note that optimal rolling speeds vary depending on material system. For instance, for very ductile mutlilayers, a relatively high rolling speed can be employed to enhance productivity without causing extensive cracking. Large rolling step deformation and slow rolling speed are helpful in obtaining solid bonding and preventing delaminating and spring-back. In particular, a rolling step deformation higher than 50% is adequate for most multilayer systems.

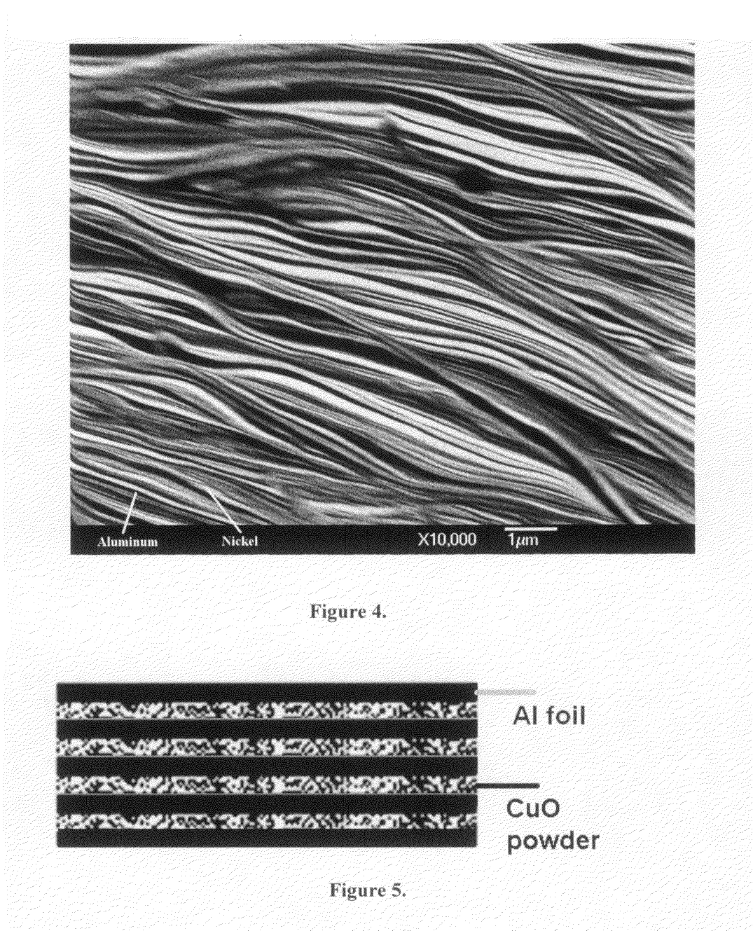

As an example, the rolling process outlined above is applied to fabrication of Ni/Al LLRCMs. As shown in FIG. 4, nanostructured LLRCMs comprising bilayers less than 100 nm thick can be obtained after rolling a stack initially consisting of 20 bilayers of 25 μm thick aluminum foil and 17 μm thick nickel foil for 33 passes.

In another example of the rolling process outlined above, a Pd/Al LLRCM is manufactured. A stack containing alternating layers of palladium and aluminum foils is prepared. Both foils are 25 μm thick. There are five Al layers and six Pd layers in the stack, giving an atomic ratio of 1:1. The Pd foil is in annealed condition and the Al foil is full-hard 5052 Al. The stack is 6″ wide and 4″ long. The stack is rolled on a 4-Hi rolling mill with work roll diameter of 1.5″ and face width of 10″. The rolling speed for the first pass is 2.5 in/min. The mill gauge is set to achieve 50% deformation for each pass. After initial bonding, the bonded foil is cut in half perpendicular to the rolling direction. The two pieces are then stacked together and subjected to another rolling pass. This stacking/rolling cycle is repeated up to 20 times. The resulting foils, upon ignition, demonstrate self propagating reaction with reaction heat of 1400 J/g and reaction velocity of 2-35 m/s, depending on the number of cycles performed.

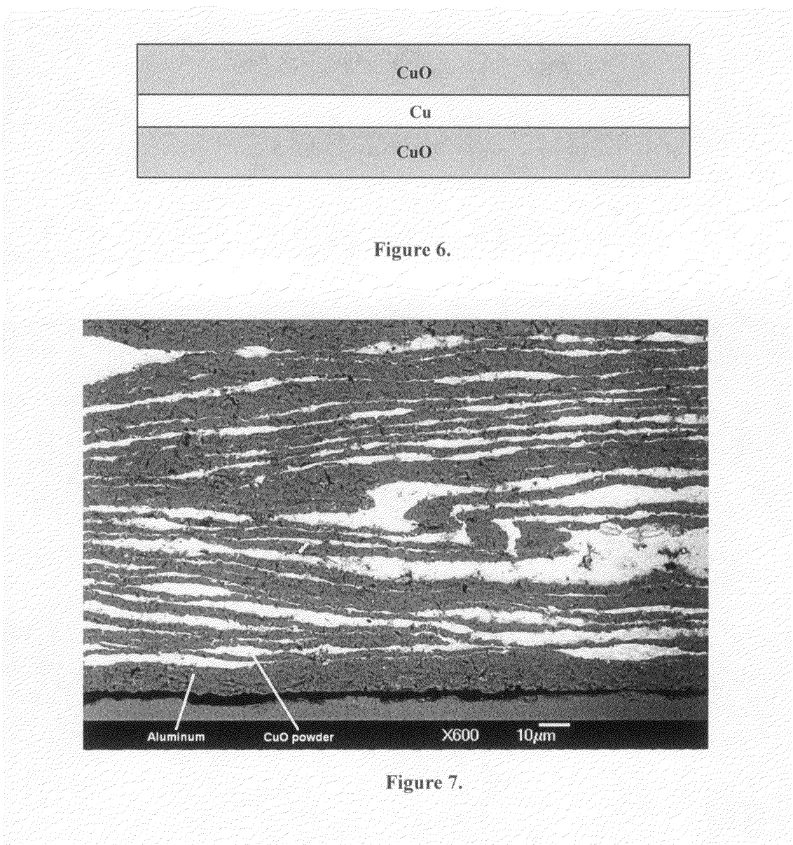

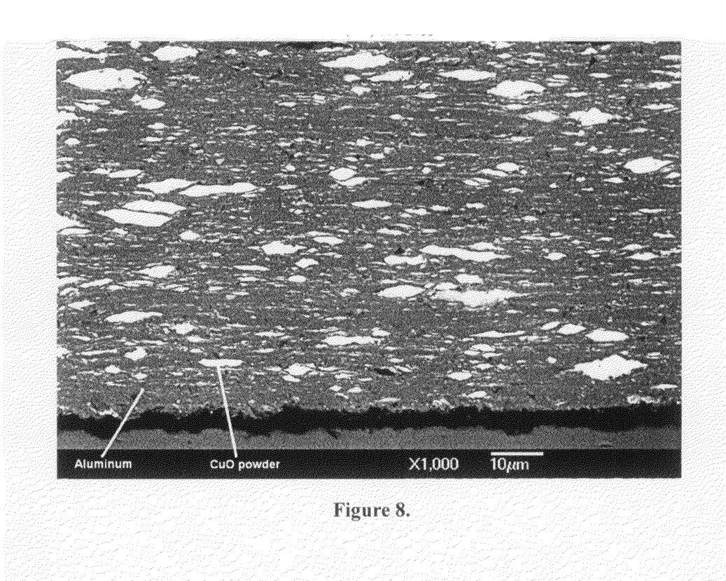

In another embodiment of this invention, the rolling process is used to fabricate LLRCMs that alternate between aluminum and copper oxide. Two initial stack configurations have been successfully evaluated. In the first, the initial stack comprises layers of aluminum foil alternating with layers of copper oxide powder (see FIG. 5). In the second, the initial stack comprises layers of aluminum foil alternating with layers of copper foil that, prior to stacking, were annealed at high temperature in air and thus have a solid copper-oxide film at both bottom and top surfaces (see FIG. 6). For both initial configurations, the evolution of the microstructure of the resulting aluminum/copper oxide multilayers has been analyzed experimentally using scanning electron microscopy. As illustrated in FIG. 7 for the aluminum/copper oxide powder configuration, the analysis shows that during rolling, the oxide powder particles layers are initially spread out with little plastic deformation. In particular, FIG. 8 shows that a fine distribution of copper oxide particles is obtained after only six rolling passes. In contrast, more than twenty rolling passes are needed to obtain such a structure when rolling Ni/Al multilayers. Thus, one advantage of the present system is that processing times can be significantly shorter compared to systems alternating between metal and/or metal alloys. An additional advantage of aluminum/copper oxide LLRCMs is that, in addition to generating heat, the reaction results in a ductile product (copper) having a high thermal conductivity. This is a useful feature in reactive joining, particularly for bonding microelectronic components such as heat sinks onto chips.

Rolling steps can be performed on laboratory-scale mills or large-scale production mills, as long as the mills can provide enough load to deform the stack or multilayer, and can run steadily at relatively low speeds. Generally, a 4-Hi mill with a power of 7 HP and a separating pressure of 690 MPa is capable of rolling most reactive systems at reasonable rates and with acceptable multilayer quality. The rollers are kept clean, free of oil, grease and other possible contaminants during rolling. The combination of dirt-free rolling environment and careful handling of the multilayers using gloves enables a metallurgical bond to form between initially unbonded layers, stacks, and/or previously-rolled multilayers. For most metal-based foils like Ni/Al and Pd/Al, lubricating oil need not be applied, and limited roller cleaning is required. However, for foils comprising powders or particles, e.g. multilayers combining dense aluminum foils with layers of copper oxide particles, the rollers need to be cleaned every several passes since particles may stick to, and consequently damage, the rollers.

It should be evident for someone skilled in the art how to extend the processing methods above, particularly to include sheath rolling, warm rolling, swaging, extrusion, hot pressing, and/or annealing.

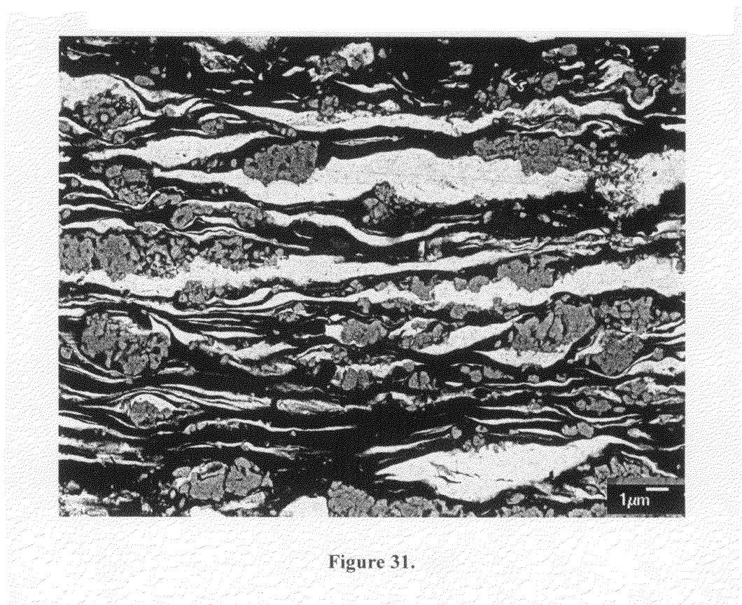

In another embodiment, the cold rolling mechanical deformation process is applied to fabricate LLRCMs comprising aluminum and nickel oxide (NiO). In one instance, the initial stack comprises layers of aluminum foil alternating with layers of NiO powder. In the second, the initial stack comprises layers of aluminum foil alternating with layers of nickel foil that have been annealed at high temperature in air to produce NiO films at the bottom and top surfaces. In the second case, the oxide layers are broken into tiny particles after about 11 rolling passes (FIG. 31). An advantage of the Al/NiO LLRCM is that, in addition to generating heat by the thermite reaction between NiO and Al, additional heat can be obtained by a subsequent formation reaction between extra Al and the Ni produced from the thermite reaction. Due to this two-step reaction, a lower volume fraction of oxide is required for a specified heat density compared with other thermite reaction systems. This permits faster, easier fabrication and a foil of greater ductility.

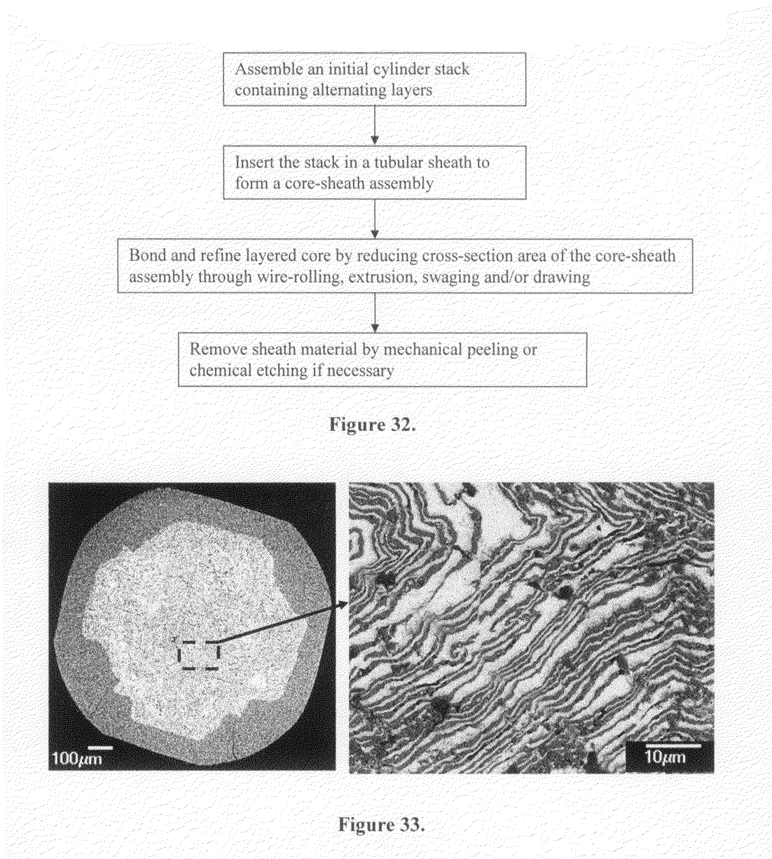

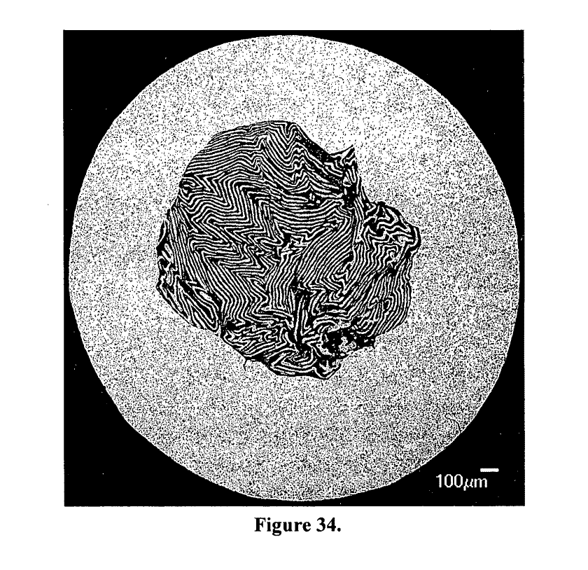

In another embodiment of the invention, locally layered reactive composite wires or rods are fabricated by mechanical deformation. FIG. 32 is a schematic block diagram showing the steps of a first approach to making such wires or rods. The first step, shown in Block A, is to provide an initial cylindrical stack containing alternate layers of two metal foils or powder/metal foil reactants. The cylindrical stack can be provided, for example, by rolling a flat stack into a cylinder. The next step (Block B) is to insert the cylindrical stack into a tubular sheath such as an aluminum or copper tube. The fit is advantageously slightly loose. The sheath can be composed of one of the reactants, e.g. the sheath for an Al/Ni stack can be an aluminum tube. The third step, shown in Block C, is to subject the tube to mechanical deformation to reduce the cross sectional area as by rolling, swaging and/or drawing deformation to consolidate and refine the LLRCM structure. The core-sheath assembly is advantageously reduced by a factor of at least 2 and up to 100 or more. During this severe plastic deformation, solid state bonding between the individual layers in the core stack is achieved, and the layer thickness is gradually reduced as the cross section area becomes smaller. The final step, which is optional in some applications, is to remove the sheath material, as by mechanical peeling or chemical etching (Block D). The final step can be omitted if the sheath is chosen to facilitate performance, as by reacting with the core or operating as a heat sink or ESD-protective sheath. FIG. 33 is a photomicrograph depicting in two different magnifications a cross section of NiO/Al LLRCM wire made in an aluminum sheath by the process of FIG. 32. The darker phase is aluminum. FIG. 34 is a photomicrograph depicting the cross section of a Ni/Al LLRCM wire in a copper sheath made by the process of FIG. 32. In the core, the dark phase is Al and the bright phase is Ni.

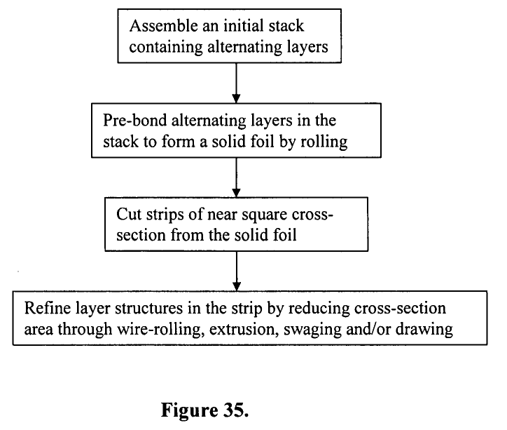

An alternative approach to wire or rod fabrication is illustrated in FIG. 35. In essence, this step involves deforming a strip—preferably a square strip—that is sectioned from a pre-bonded multilayer foil or sheet. The first two steps of this method (Blocks A and B) are similar to the processes used for rolling reactive foils: assemble a stack comprising alternating layers and bond the layers together by cold rolling. In the third step, Block C, the pre-bonded foil is sectioned to provide narrow strips with near-square cross section. The dimension of these strips is determined by the thickness of the pre-bonded foil. The next step, shown in Block D, is to reduce the cross section area and modify the cross section geometry by using one or more conventional wire processing techniques, as mentioned above. An advantage of this approach is that the technical complications associated with sheathing and unsheathing are avoided by working on bare reactive wires instead of core-sheath structures.

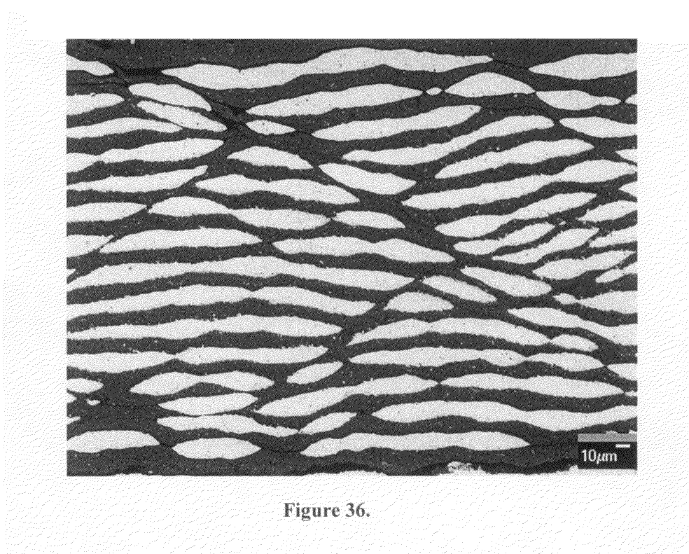

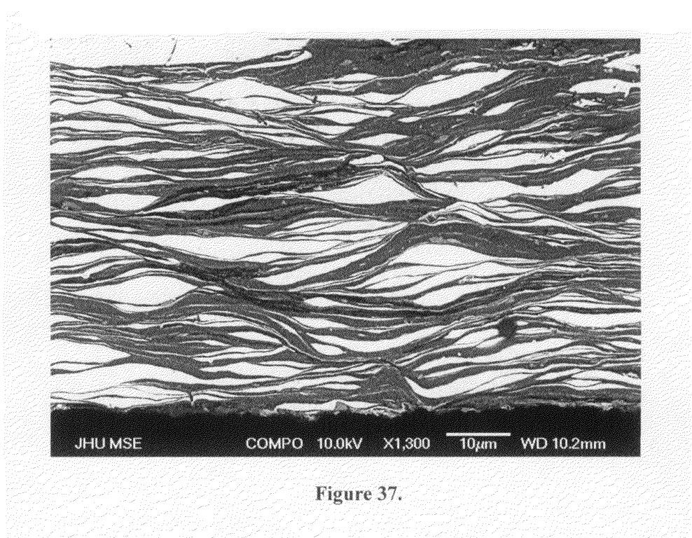

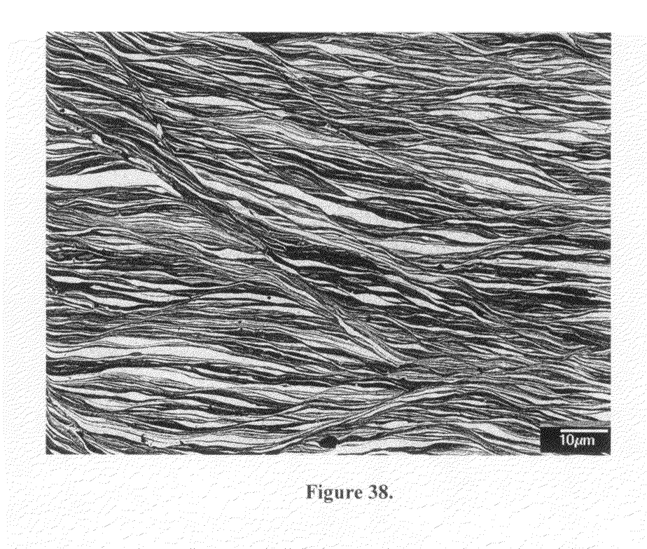

We now turn from the methods of forming LLRCMs that use mechanical deformation to the resulting products. The structures made by mechanical deformation differ from those made by physical vapor deposition (PVD structures) in a number of respects relating to layer length, microstructure, internal geometry and variations in thickness. PVD structures tend to comprise very long layers of essentially uniform thickness that are parallel to the foil surface. Such structures are referred to herein as uniformly layered. While reactive composite materials made by mechanical formation may be uniformly layered (e.g. FIG. 3), this microstructure is only observed in the early stages of mechanical formation during which deformation primarily induces elongation of the individual layers. Rolling thus enables the formation of uniformly layered structures having thick bilayers (e.g. 1 micrometer or more), that are not possible to form by PVD because the process would be extremely slow or perhaps impossible due to stresses. At later stages of mechanical formation, the uniform layering is lost and the resulting reactive composite materials are locally layered structures that can be distinguished by the aspect ratio of individual layers, the curvature of the layers in three dimensions, inclination of the layers with respect to the foil surface or rolling direction, and by variability in thickness among individual layers. For the presently disclosed rolling process, four types of structures can be distinguished in LLRCMs according to the average aspect ratio of the individual layers: (a) “distributed particulate structures,” with mean aspect ratio ranging between about 1 and 5 (FIG. 31); (b) “island structures,” with mean aspect ratios ranging between about 5 and 10 (FIG. 36); (c) “short non-uniformly layered structures,” with mean aspect ratios ranging between about 10 and 30 (FIG. 37); and (d) “long non-uniformly layered structures,” with mean aspect ratios larger than about 30 (FIG. 38).

Previous efforts dealing with mechanical rolling^{5,8} have reported island structures that tend to quench the self-propagating reaction. Applicants, in contrast, have found that the predictable reaction behavior of the distributed-particulate, short non-uniformly layered, and long non-uniformly layered structures has not been previously reported.

An additional distinction between PVD structures and LLRCM structures made by mechanical formation concerns the orientation of the layers with respect to the foil surface. In PVD structures, the individual layers are essentially flat and parallel to the foil surface. In contrast, most layers in cold rolled LLRCMs are inclined with respect to the foil surface, with inclination angles ranging between 5 and 30 degrees. The inclination can be attributed to 1) necking of the harder of the two phases and subsequent elongation of the necked area and 2) deformation by shear along shear bands that are about 30 degrees above and below the plane of the rolling direction (FIG. 38).

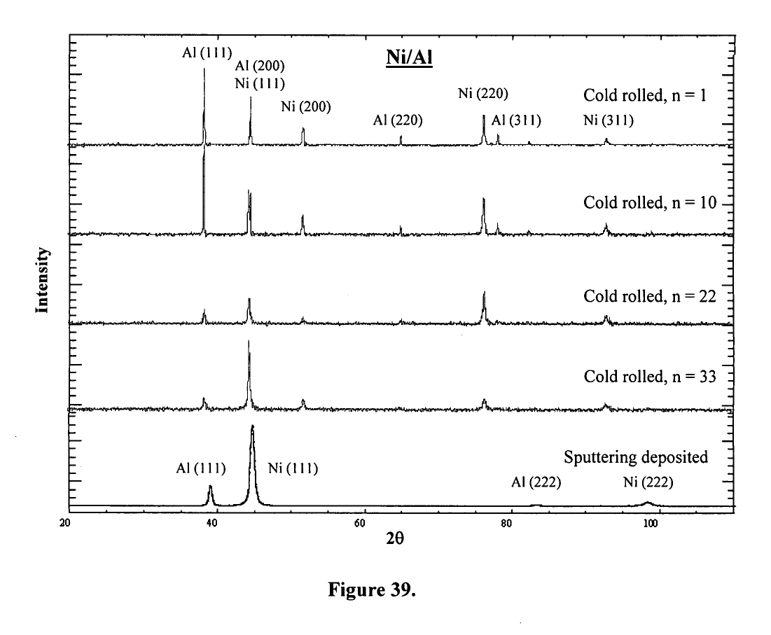

Texture of the material can be also be used as a distinguishing feature among different as-rolled LLRCMs made by mechanical formation, and between as-rolled LLRCMs and as-deposited PVD materials. X-ray diffraction traces for cold rolled Ni/Al LLRCMs at different stages of deformation are plotted in FIG. 39; the trace of a deposited RCM is also included for comparison. One can observe from these results that PVD materials exhibit much stronger texture than mechanically-formed composite materials. Specifically, for the PVD material, the reflection is dominated by (111) plane for both Al and Ni. On the other hand, for the mechanically-formed LLRCMs, reflections from other planes are significant. Another observation is that the mechanically-formed LLRCMs show a texture evolution with increasing rolling passes; an example concerns the change of relative intensity of the (220) reflection when n=10 (short non-uniformly layered structure), n=22 (long non-uniformly layered structure) and n=33 (long non-uniformly layered structure). In contrast, PVD RCMs always have texture characteristics like those shown in FIG. 39. In addition, the broadening of reflections with increasing rolling passes indicates refinement of grain size as deformation proceeds, which is in contrast with the constant crystalline structure characteristic of PVD structures.

In distinguishing LLRCMs from reactive powder compacts, two differences are observed. First, LLRCMs include non-powder layers, i.e. foils. These layers are necessary to carry the powders through the deformation processes. Typical powder concentrations in initial stacks do not exceed 20% by volume, in order to permit the layers to bond together. Secondly, cold-pressed powder compacts typically contain a minimum of 15% porosity by volume. Mechanically formed LLRCMs, in contrast contain negligible porosity and may be considered “continuous” materials. The distribution of reactants in mechanically formed LLRCMs, as presented here, is typically random and non-uniform, but with distinct anisotropy due to the directional nature of the deformation used to create these RCMs. In this application, “locally-layered” describes the reactant distributions produced by the mechanical formation methods described herein, whether the reactants are initially foils, sheets, or powders, and regardless of which of the four specific types of structures discussed above are observed.

II. Features of the Resulting Products and Control Thereof

The refinement of the multilayer material can be observed experimentally using scanning electron microscopy (SEM). SEM observations may be conducted following individual rolling passes to observe how the bilayer thickness reduces locally due to the deformation.

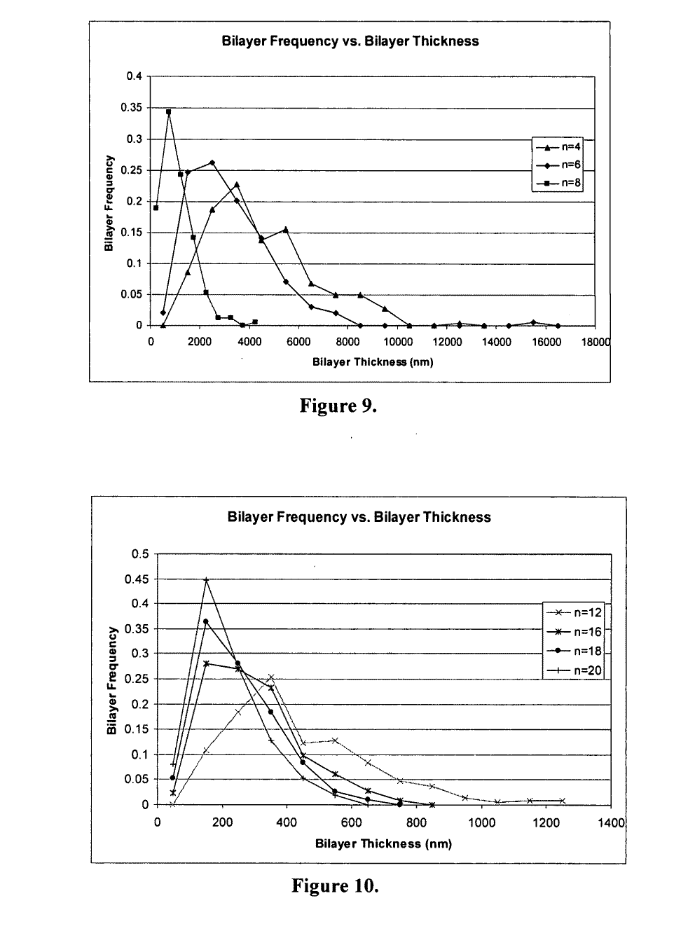

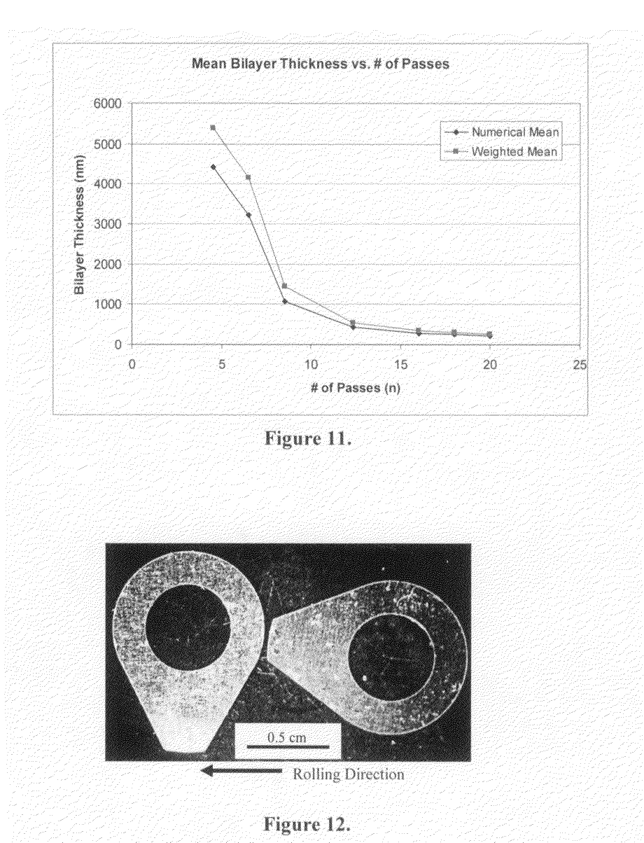

In one embodiment of this invention, the evolution of the microstructure in mechanically rolled foils can be measured using optical and SEM micrographs. A linear intercept method can then be applied along lines perpendicular to the rolling direction in order to determine the distribution of bilayers within the rolled multilayer. By this method, the individual bilayer thickness can then directly determined by measuring the distance between the outside boundaries of two adjacent elemental layers. Variation in bilayer thickness can be treated as a frequency distribution. About 200 bilayer measurements are necessary to produce a reasonable statistical sample. As an example, the frequency distributions of bilayer thickness for rolled Pd/Al foil are shown in FIGS. 9 and 10. It can be seen that the data for each foil fit a log-normal-type distribution and the peak of this distribution tightens and shifts to smaller values with increasing rolling passes. To observe the general trend of bilayer thickness evolution during rolling, mean values of bilayer thickness, both numerical and weighted, are extracted from the individual distributions and plotted in FIG. 11 as a function of number of passes. The numerical mean (δₐᵥ) and weighted mean (δ_{w}) are defined by equations 1 and 2, respectively,

$$\begin{matrix}{δ}_{av} = \frac{1}{N} {\sum }_{i = 1}^{N} {δ}_{i} & ( 1 ) \\ {δ}_{w} = \frac{{\sum }_{i = 1}^{n} {δ}_{i}^{2}}{{\sum }_{i = 1}^{n} {δ}_{i}} & ( 2 )\end{matrix}$$

where δᵢ is the thickness of the bilayer i and N is the number of measured bilayers.

Under ideal conditions, the bilayer thickness would reduce uniformly across the material, and the thickness reduction would be essentially 2^{N} after N rolling passes. This ideal scenario is seldom achieved in practice, since the deformation of the individual layers is not uniform. Accordingly, the material becomes characterized by a bilayer distribution, and the “mean” or “effective” refinement rate is appreciably smaller than that of the ideal scenario. For instance, the mean bilayer thickness of Pd/Al foil is measured to be 340 nm after 16 rolling passes (FIG. 11) while the idealized bilayer thickness is predicted to be 0.76 nm.

The bilayer distribution may be used to characterize distributed particulate structures and island structures as well as long and short non-uniformly layered structures by using the anisotropy due to the present mechanical formation method. The bilayer thickness is measured in the same manner as above. Placing the intercept line normal to the rolling direction on a cross-section produces a suitably accurate distribution of reactant region dimensions, given enough measurements.

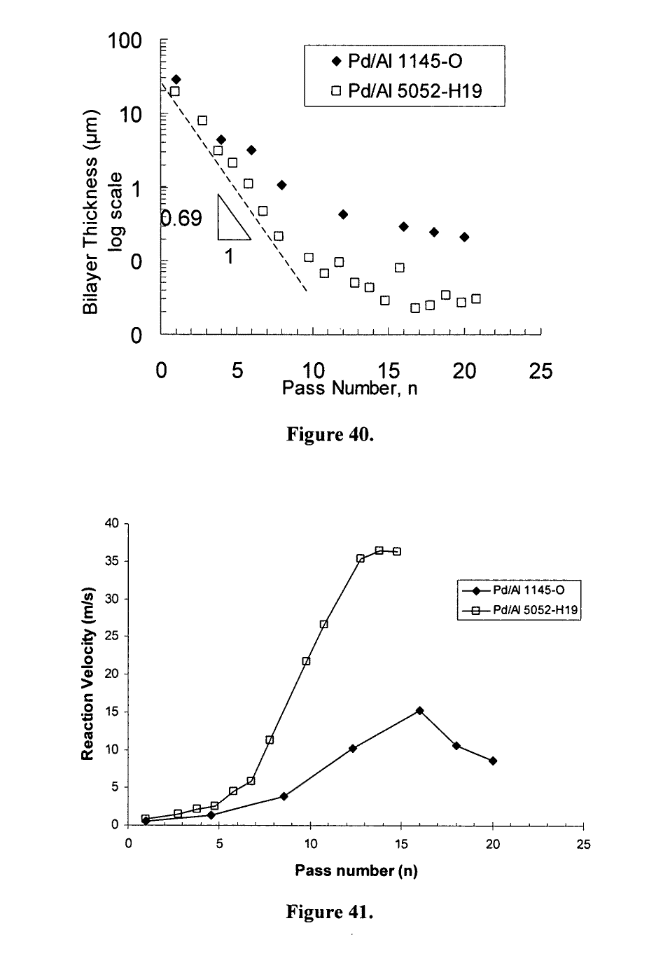

In another embodiment of this invention, it is observed that two factors contribute to the non-uniformity in bilayer distribution: misalignment during stacking and mismatch of deformation properties between different layers. When misalignment occurs when two pieces of Ni/Al foil are stacked for rolling, the misaligned region, with thickness of half of the aligned (overlapped) region, undergoes little deformation during the rolling step and thus the layers in that region are not refined. Mismatched deformation properties affect the bilayer distribution throughout the entire material. In the case of nickel and aluminum, since the softer aluminum phase bears the majority of deformation, only slight thinning in the nickel phase takes place during rolling. FIG. 37 shows thick, non-uniform nickel layers and thin, more uniform aluminum layers. In order to improve bilayer refinement (both rate and uniformity) one can (i) use larger samples so as to reduce the fraction of misaligned region, and (ii) use reactant materials with similar hardnesses (hardness ratio less than 1.5:1) to distribute deformation evenly in the foil. To optimize the hardness ratio, one can (i) repeatedly cold roll the softer reactant foil to pre-harden it before multilayer stacking, (ii) select initial foils with desired temper (hard or soft), and (iii) use pure metals or alloys with similar composition but different hardness. For example, 5052 Al foil is much harder than commercial purity 1145 Al. Plotted in FIG. 40 are bilayer thickness vs. pass number for two Pd/Al LLRCMs made with two different aluminum alloys: Al 1145-O has a Vickers hardness (HV) of 25, while Al 5052-H19 has a Vickers hardness of 99, much closer to that of pure palladium, 75. In the plot, the LLRCM made with Al 5052-H19 exhibits nearly ideal deformation (shown by the dotted line) through eight passes, while the LLRCM made with the softer aluminum deviates from ideal deformation after four passes.

In another embodiment, the mechanical rolling process is used to fabricate foils having high ductility. Unlike sputter-deposited multilayers which tend to be brittle (and consequently susceptible to cracking and/or unwanted ignition during mechanical processing such as shearing, stamping, and punching), mechanically-rolled multilayers are fairly ductile and may be readily punched, sectioned, cut, sheared or stamped with little risk of brittle fracture or unwanted ignition. For example, washer shape components with excellent edge quality can be punched from rolled Ni/Al reactive foils (see FIG. 12). In addition, due to the fact that mechanically-rolled foils can deform plastically at room temperature, it is also possible to clad them with other materials like solder or braze by mechanical rolling. The resulting composite structures may thus be effectively used in a variety of applications, including reactive multilayer soldering and brazing.

In another embodiment, a reactive multilayer material that has a selectable reaction velocity can be produced using mechanical rolling. As further described below, properties of the self-propagating reactions in the present mechanically-rolled multilayers, including reaction heat and velocity, are functions of the microstructural properties of the multilayer resulting from the rolling process. In turn, the latter may be modified or controlled by varying process parameters. Thus, a multilayer with selectable propagation velocity can be obtained. This is an advantage of the present invention, since control of reaction velocity has previously only been demonstrated for multilayer structures having a uniform bilayer thickness.

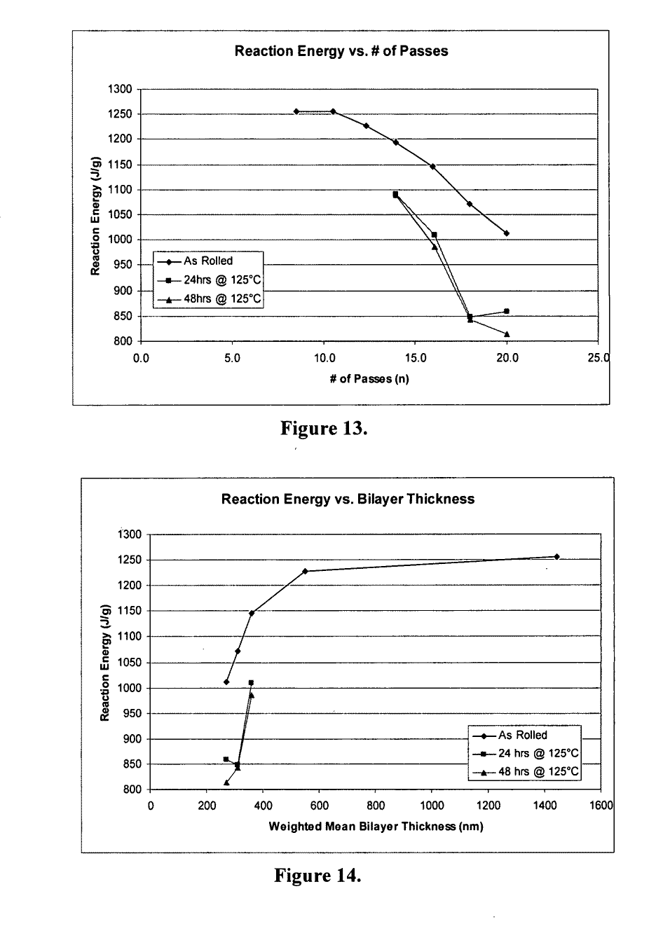

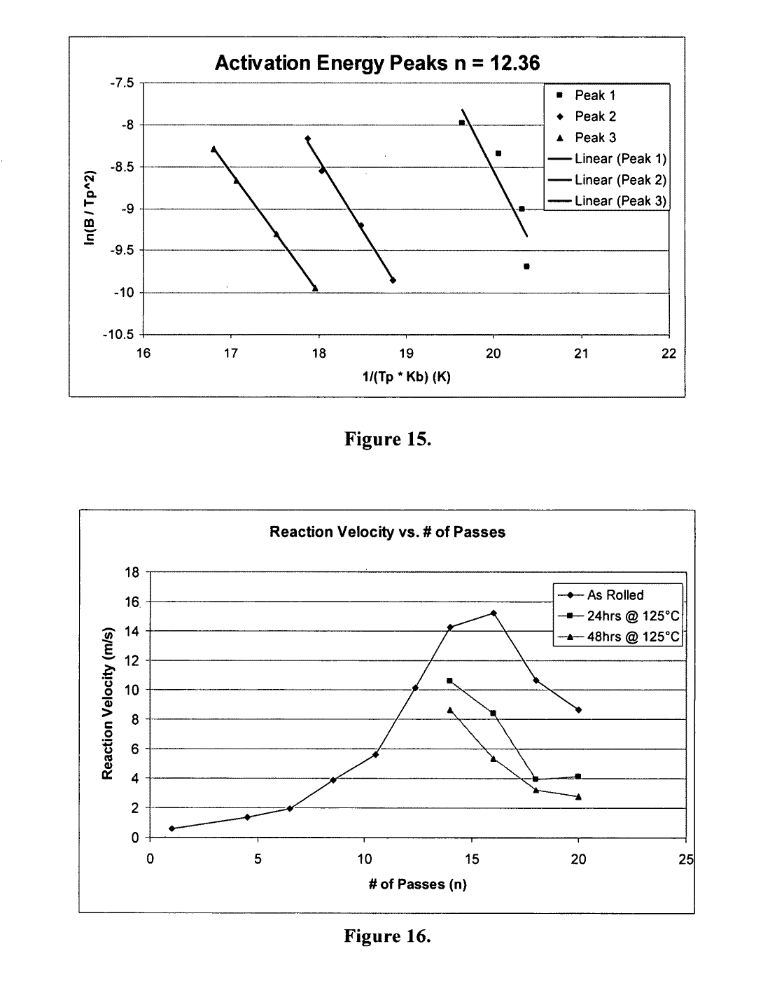

In another embodiment of this invention, heat of reaction in rolled RCMs is characterized as a function of number of rolling passes, using differential scanning calorimetry (DSC). Plotted in FIG. 13 are the reaction energies versus the number of passes for as-rolled and annealed Pd/Al foils. The data show that reaction heat decreases from 1260 J/g to 1100 J/g as the pass number increases from 7 to 20. This heat loss is most likely due to intermixing of the reactants at the layer interfaces. The figure shows that annealing lowers the heat of reaction. It is known that annealing increases the intermixing of the reactants due to diffusion. Also, the losses occur at very fine bilayer thicknesses, as shown in FIG. 14, when the interfacial surface area is very large and after a large amount of mechanical processing. Therefore, intermixing is expected to be high. A Kissinger analysis can be conducted using DSC data (peak temperature shift as a function of heating rate) to calculate the average activation energy for phase formation in the rolled RCMs. An example is given in FIG. 15. The sample is cold rolled Pd/Al foil after 12 passes, with 550 nm weighted mean bilayer thickness. The activation energy, which is deduced from the flattest slope of the linear fit lines in the plot, has a value of 1.5 eV.

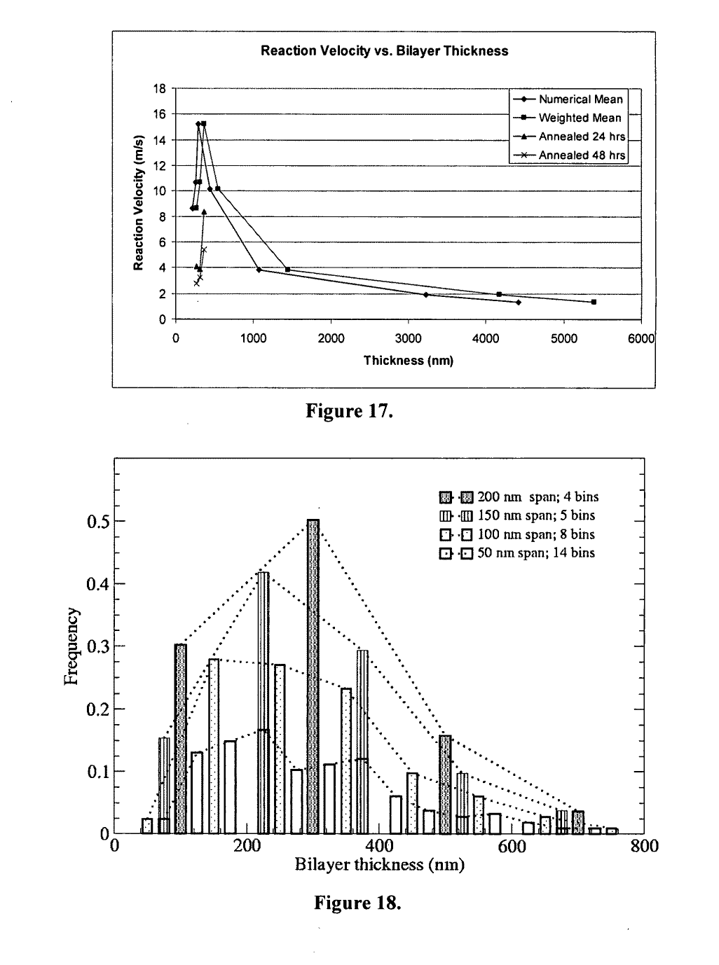

In another embodiment of this invention, the reaction velocity of rolled LLRCMs is determined as a function of the number of rolling passes. As an example, measured velocity for Pd/Al foils is plotted against the number of passes in FIG. 16 and weighted mean bilayer thickness in FIG. 17. Included are the velocities for rolled and annealed samples. As shown in FIG. 16, the foil demonstrates self-propagating reaction after two rolling passes and the propagation velocity increases from 0.4 m/s to 14.5 m/s as the number of rolling passes increases from 2 to 16. Then the velocity starts to drop, primarily due to deformation-induced intermixing. This issue is further investigated by annealing rolled foils at 125° C. in inert gas for 24 and 48 hrs. Slower velocities are observed for the annealed samples, in which intermixing is enhanced by diffusion, suggesting that intermixing plays a role in determining how fast the reaction propagates. This is further supported by the fact that velocity drops when bilayer thickness becomes very small (FIG. 17). In a finer bilayer structure a higher volume fraction of intermixed material exists (as outlined above) and therefore a more significant effect on propagation velocity, as well as heat of reaction, is observed (also see FIG. 14).

In another embodiment of this invention, LLRCM composition can be managed to control reaction properties. It is not necessary that the atomic ratio of reactants be stoichiometric for some applications. A change in composition can influence reaction properties by (i) including extra inert material that will serve as heat sink during reaction and (ii) forming different reaction products with different heats of reaction. For example, two stacks of Pd/Al foils, with Pd:Al atomic ratios of 1:1 and 2:3, were cold rolled using identical procedures. It was found that the reaction in the aluminum-rich foil released less heat per volume material and propagated at lower speed. According to the aluminum-palladium phase diagram, an atomic ratio of 1:1 produces one intermetallic compound, PdAl, while an atomic ratio of 2:3 produces a different compound, Pd₂Al₃, with lower heat of formation. There are several ways to adjust overall composition in order to achieve desired reaction property: (i) varying foil thickness and/or foil numbers in initial stacks, (ii) adding extra reactant or inert foils in stacks after certain pass numbers, and (iii) cladding extra materials to the surface of reactive foils during final rolling.

In another embodiment of this invention, rolling deformation can be managed to control reaction properties. LLRCMs become reactive after certain numbers of rolling passes as a result of structure refinement. Additional rolling may be applied to further reduce the bilayer thickness for ease of ignition and enhanced kinetics. For a particular material system, a model describing the relationship between rolling deformation, local layer structure and reaction kinetics can be established based on experiment to predict reaction properties in LLRCMs rolled different amounts. With this model, one can design a rolling procedure to fabricate a desired LLRCM by producing the deformation required to achieve the desired structure and properties.

In another embodiment of this invention, the microstructure in rolled LLRCMs can be modified by post-rolling annealing to control reaction properties. When an LLRCM's reaction heat and velocity are too large, low temperature annealing can be carried out to increase intermixing in the microstructure. Annealing is also helpful to enhance stability by increasing ignition energy thresholds. By selecting an appropriate annealing time and temperature, a quantitative change in properties can be obtained accurately.

In another embodiment of this invention, material properties, e.g. hardness matching, can also be utilized to control reaction properties. For example, 7 rolling passes are required to achieve self-propagating reaction in a Ni/Al LLRCM with a starting Ni:Al hardness ratio of 1:1 (using full-hard aluminum alloy 5052 and annealed pure nickel) compared with 18 rolling passes to obtain similar reaction properties in another Ni/Al LLRCM with initial hardness ratio of 2.5:1 (using as-rolled pure aluminum and annealed pure nickel). In another example, FIG. 41 shows the reaction velocity vs. weighted mean bilayer thickness for two Pd/Al LLRCMs made with two aluminum alloys, as described above. The LLRCM in which the hardnesses of the starting materials were well matched (hardness ratio of 1.27:1) displayed much higher velocities than the other LLRCM (hardness ratio 3:1) for the same amount of processing. FIG. 41 shows the difference in weighted mean bilayer thickness for the same two LLRCMs.

In another embodiment of this invention, LLRCM geometry, e.g. thickness, can also be utilized to control reaction properties. For example, heat generation per unit surface area may be controlled by varying the final LLRCM thickness via rolling. Since heat release is a function of volume, a thinner LLRCM will release less heat per unit area.

We now discuss how the self-propagating reactions in rolled reactive composite materials can be mathematically modeled and discuss the further embodiments of the invention that this modeling permits. The properties of self-propagating reactions in rolled LLRCMs are determined using a transient multi-dimensional computational model. The newly developed model below is a generalized version of the model outlined in a paper by E. Besnoin, et al.¹⁶, which is only suitable for dealing with multilayer materials having uniform layering, i.e. situations in which the chemical composition profile across the foil is essentially independent of lateral or axial position. As discussed earlier, most mechanically-formed multilayers disclosed herein are characterized by non-uniform layering, so that application of existing models is unsuitable for the purpose of predicting their properties. To overcome this hurdle, this invention introduces a stochastic computational model that is developed to describe the non-uniform layering produced by the formation process outlined above.

The presently-developed stochastic model is based on the following assumptions: (1) atomic mixing can be described as a Fickian process using a single, temperature-dependent, binary diffusion coefficient, D; (2) the thermal conductivity of the foil is independent of temperature and composition; and (3) the reaction is described by a fast, diffusion-limited process. Furthermore, since thermal diffusivity is several orders of magnitude larger than atomic diffusivity, temperature variations across the layers can be ignored, so that the temperature distribution varies only with axial position (x) and time. It should be evident for someone skilled in the art how to relax the present assumptions, e.g. to account for the temperature dependence of thermal conductivity, or to incorporate more elaborate models of atomic mixing.

Atomic mixing within a single bilayer is described in terms of the following evolution equation for a conserved scalar, C:

$$\frac{d C}{d t} - ∇ \cdot ( D ∇ C ) = 0 \qquad ( 3 )$$

When adjacent layers comprise two reactive materials, generically denoted A and B, respectively, the conserved scalar field may be defined such that C=1 for material A, C=−1 for material B, and C=0 for the product of the reaction or the mixed phase as the case may be. For instance, for Ni/Al multilayers with 1:1 ratio of reactants, C=1 for pure Al, C=−1 for pure Ni, and C=0 for pure NiAl.

The atomic diffusivity, D, is assumed to be independent of composition and to follow an Arrhenius dependence on temperature, according to:

$$D = {D}_{o} exp ( - \frac{E}{RT} ) \qquad ( 4 )$$

where Dₒ is the Arrhenius pre-exponent, E is the activation energy and R is the universal gas constant. The values of E and Dₒ used in the embodiments below are obtained from best fits to experimental data. In particular, for the Ni/Al system, we use E=137 kJ/mol and Dₒ=2.18×10⁻⁶ m²/s (from Mann, et al.¹⁷); for the Pd/Al system, the requisite values were not readily available and were thus determined directly from present measurements.

As discussed above, experimental observations reveal that the rolling process described herein results in non-uniform local layering within the material, which may be described in terms of a bilayer distribution. This distinguishes these new materials from previously characterized vapor-deposited multilayers which have essentially uniform layering.

In one embodiment of this invention, the non-uniform layering of the material is accounted for using the measured probability density function (PDF) of the bilayers. To this end, the measured PDF is discretized into a finite number of bins, resulting in a finite array of bilayers, δᵢ, i=1, . . . , N, and weights, ξᵢ, i=1, . . . , N, where N is the total number of bins. By definition, we have

$${\sum }_{i = 1}^{N} {ξ}_{i} = 1.$$

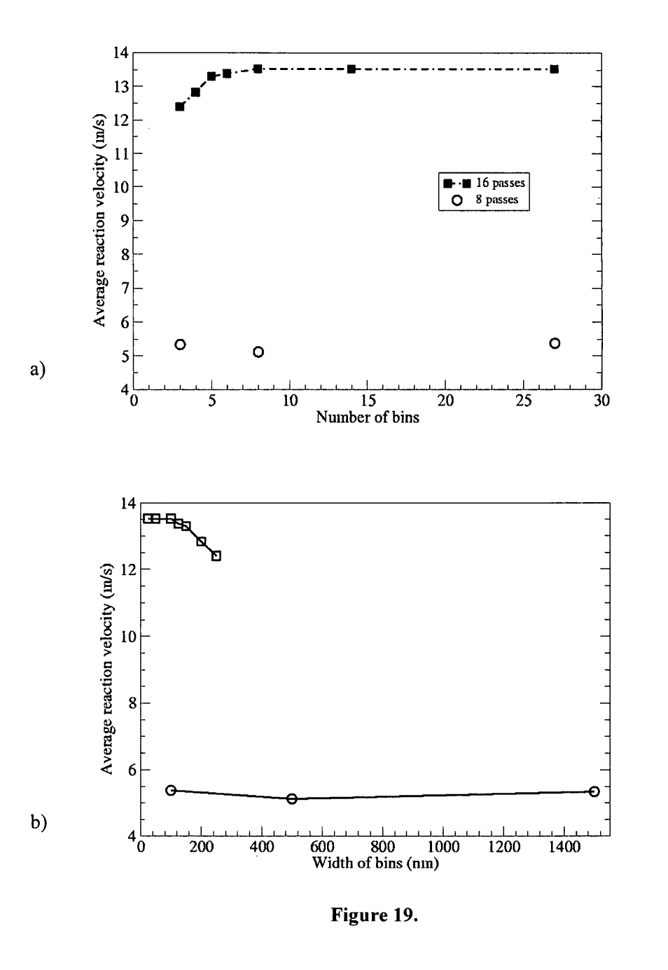

The total number of bins and the span of the bins (FIG. 18) are chosen in order to ensure convergence of the predictions. For instance, as shown in FIG. 19, predictions converge (i.e. become essentially independent of the number of bins) if eight or more bins are used to model the PDF of Pd/Al rolled foils.

In another embodiment of this invention, the development of the computational model takes advantage of experimental observations that the reaction front propagates in a uniform fashion across the material, which indicates that the temperature profile in neighboring bilayers is essentially flat. We take advantage of these observations by solving Eq. (3) within N bilayers having bilayer widths δᵢ, i=1, . . . , N, respectively. In the model results below, the solution is based on discretizing Eq. (3) within each of the bilayers using a regular grid, and numerically integrating the resulting system of discrete equations¹⁶. It should be evident for someone skilled in the art how to apply various other discretization schemes, such as finite-element, finite-volume, spectral, and spectral-element approximations.

Based on the observations above, the evolution of the concentration fields within the N bilayers is coupled with the section-averaged energy equation:

$$\frac{d H}{d t} = ∇ \cdot ( \overline{k} ∇ T ) + \frac{d \overline{Q}}{d t} \qquad ( 5 )$$

where H is the section-averaged enthalpy, the overbar denotes averaging over the cross section,

$$\overline{k} ≡ \frac{{k}^{A} + γ {k}^{B}}{1 + γ} \qquad ( 6 )$$

is the mean thermal conductivity, k^{A} and k^{B} are the thermal conductivities of materials A and B, respectively,

$$γ ≡ \frac{{ρ}^{A}}{{ρ}^{B}} \frac{{M}^{B}}{{M}^{A}} \qquad ( 7 )$$

ρ^{A} and ρ^{B} are the densities of materials A and B, while M^{A} and M^{B} denote the corresponding atomic weights.
Experimental data¹⁸ indicates that the variation of the heat of reaction, Q, with composition, C, can be closely approximated as:

Q(C)=ΔH_{f}C² (8)

where ΔH_{f} is the heat of reaction. Thus, the averaged reaction source term can be expressed as:

$$\frac{\partial \overline{Q}}{\partial t} = - \frac{{\sum }_{i = 1}^{N} {ξ}_{i} {δ}_{i} [ \overline{ρ {c}_{p}} Δ {T}_{f} \frac{\partial }{\partial t} ( \frac{1}{{δ}_{i}} {\int }_{0}^{{δ}_{i}} {C}^{2} d y ) ]}{{\sum }_{i = 1}^{N} {ξ}_{i} {δ}_{i}} \qquad ( 9 )$$

where y is the direction normal to the layers,

$$\overline{ρ {c}_{p}} ≡ \frac{{ρ}^{A} {c}_{p}^{A} + {γρ}^{B} {c}_{p}^{B}}{1 + γ} \qquad ( 10 )$$

cₚ^{A} and cₚ^{B} respectively denote the heat capacities of materials A and B. Note that when melting is ignored, ΔT_{f} represents the difference between the adiabatic flame temperature, T_{fo}, and the ambient temperature, Tₒ.

Incorporation of melting effects results in a complex relationship between H and T, involving the heats of fusion of the reactants and products. Without loss of generality, we may assume that Tₘ^{A}, the melting temperature of material A, is smaller than Tₘ^{B}, the melting temperature of material B, which in turn is smaller than Tₘ^{C}, the melting temperature of the reaction products or of the mixed phase. With this convention, the relationship between H and T may be expressed as:

$$T = \{ \begin{matrix}{T}_{0} + \frac{H}{\overline{ρ {c}_{p}}} & if H < {H}_{1} \\ {T}_{m}^{A} & if {H}_{1} < H < {H}_{2} \\ {T}_{m}^{A} + \frac{H - {H}_{2}}{\overline{ρ {c}_{p}}} & if {H}_{2} < H < {H}_{3} \\ {T}_{m}^{B} & if {H}_{3} < H < {H}_{4} \\ {T}_{m}^{B} + \frac{H - {H}_{4}}{\overline{ρ {c}_{p}}} & if {H}_{4} < H < {H}_{5} \\ {T}_{m}^{C} & if {H}_{5} < H < {H}_{6} \\ {T}_{m}^{C} + \frac{H - {H}_{6}}{\overline{ρ {c}_{p}}} & if {H}_{6} < H\end{matrix} \qquad ( 11 )$$

where h_{f}^{A}, h_{f}^{C}, and h_{f}^{C} are the heats of fusion (per unit mole) of materials A, B, and C,

$$\begin{matrix}α = \frac{{\sum }_{i = 1}^{N} {ξ}_{i} {\int }_{0}^{{δ}_{i}} {C}_{i} d y}{{\sum }_{i = 1}^{N} {ξ}_{i} {δ}_{i}} & ( 12 ) \\ β ≡ α / ( 1 + γ ) & ( 13 ) \\ Δ {H}_{f}^{A} ≡ {ρ}^{A} {h}_{f}^{A} / {M}^{A} & ( 14 ) \\ Δ {H}_{f}^{B} ≡ {ρ}^{B} {h}_{f}^{B} / {M}^{B} & ( 15 ) \\ Δ {H}_{f}^{C} ≡ {\overline{ρ h}}_{f}^{C} / {M}^{C} & ( 16 ) \\ \overline{ρ} ≡ ( {ρ}^{B} + {γρ}^{B} ) / ( 1 + γ ) & ( 17 ) \\ {H}_{1} = \overline{ρ {c}_{p}} ( {T}_{m}^{A} - {T}_{o} ) & ( 18 ) \\ {H}_{2} = {H}_{1} + βΔ {H}_{f}^{A} & ( 19 ) \\ {H}_{3} = {H}_{2} + \overline{ρ {c}_{p}} ( {T}_{m}^{B} - {T}_{m}^{A} ) & ( 20 ) \\ {H}_{4} = {H}_{3} + βγΔ {H}_{f}^{B} & ( 21 ) \\ {H}_{5} = {H}_{5} + \overline{ρ {c}_{p}} ( {T}_{m}^{C} - {T}_{m}^{B} ) & ( 22 ) \\ {H}_{6} = {H}_{5} + ( 1 - α ) Δ {H}_{f}^{C} & ( 23 )\end{matrix}$$

Note that the “enthalpy” levels H₂, . . . , H₆ are dependent on the local composition, and are consequently variable during the computations. For instance, in the limiting case α=0, the product is absent and the temperature is only affected by melting of the reactants. Conversely, for α=1 mixing is complete and the temperature only depends on the heat of fusion of the product.

In another embodiment of this invention, the physical model may be implemented in its 2D, axisymmetric or 3D forms. For brevity, we outline the 2D and axisymmetric variants, as it should be clear from these variants for someone skilled in the art how to apply the model in its 3D form. In the 2D formulation, a coordinate system (x, y) is used such that x points along the direction of reaction propagation, while y points in the direction normal to the layers. In the axisymmetric formulation, the equations are solved in a cylindrical (r, y) coordinate system, with r and y respectively normal to the surface of the reaction front and the layers of the foil. The axisymmetric and 2D models share the same physical formulation outlined above. The primary difference concerns expressions of the gradient diffusion terms, ∇·(k∇T) and ∇·(D∇C). In the 2D case, these are expressed as:

$$∇ \cdot ( k ∇ T ) = \frac{\partial }{\partial x} ( k \frac{\partial T}{\partial x} ) + \frac{\partial }{\partial y} ( k \frac{\partial T}{\partial y} ) and \\ ∇ \cdot ( D ∇ C ) = \frac{\partial }{\partial x} ( D \frac{\partial T}{\partial x} ) + \frac{\partial }{\partial y} ( D \frac{\partial C}{\partial y} ) \qquad ( 24 )$$

while in the axisymmetric case we have:

$$∇ \cdot ( k ∇ T ) = \frac{1}{r} \frac{\partial }{\partial r} ( kr \frac{\partial T}{\partial r} ) + \frac{\partial }{\partial y} ( k \frac{\partial T}{\partial y} ) and \\ ∇ \cdot ( D ∇ C ) = \frac{1}{r} \frac{\partial }{\partial r} ( Dr \frac{\partial T}{\partial r} ) + \frac{\partial }{\partial y} ( D \frac{\partial C}{\partial y} ) \qquad ( 25 )$$

Other aspects of the formulation remain essentially the same.

Note that in the 2D model, the self-propagating reaction front is essentially flat, and moves away from the plane of ignition. On the other hand, in the axisymmetric case the reaction front propagates radially, away from the ignition source.

In one embodiment of this invention, a FORTRAN code is used to implement the models outlined above. These models may be effectively implemented on a variety of computer platforms, such as Windows, Unix or Linux systems, including personal computers, laptops, workstations or mainframes. It should be evident for someone skilled in the art how to implement this on any computing platform providing memory and processor, using either low- or high-level computing languages.

In another embodiment of this invention, initiation of the reaction with the reactive multilayer material is modeled by simulating an ignition stimulus. As outlined in U.S. application Ser. No. 10/959,502 (the '502 application, previously identified), a variety of means can be utilized for this purpose, including initializing the computations using a thermal pulse, or accounting for internal dissipation due to Ohmic heating. It should be evident for someone skilled in the art how to apply the present stochastic model, following the methodology outlined in the '502 application, to determine ignition thresholds for the presently-introduced locally-layered structures.

In another embodiment of this invention, DSC measurements may be used to estimate the intermixing between otherwise chemically distinct layers. In situations where the layering is uniform, as discussed in the Mann paper¹⁷, intermixing may be described in terms of a premix width, w. Using the measured heat of reaction from DSC ΔHᵣₓ, (plotted in FIG. 21), the premix width, w, may be estimated from:

$$Δ {H}_{rx} = Δ {H}^{th} ( 1 - \frac{2 w}{δ} ) \qquad ( 26 )$$

where ΔH^{th} is the theoretical value in the absence of any intermixing. While Eq. (26) was obtained for multilayers with uniform δ, it may still be applied to the present structure if one treats the ratio 2wᵢ/δᵢ as constant for all the bilayers, i.e. for i=1, . . . , N. We refer to this estimate as Model 2. An alternative approach would be based on considering that w is uniform for all the layers; in this case, w may be estimated from:

$$Δ {H}_{rx} = Δ {H}^{th} \frac{{\sum }_{i = 1}^{N} ( 1 - \frac{2 w}{{δ}_{i}} ) {ξ}_{i} {δ}_{i}}{{\sum }_{i = 1}^{N} {ξ}_{i} {δ}_{i}} \qquad ( 27 )$$

We refer to this approach as Model 1. As discussed below, for the class of materials disclosed in the present invention, both approaches yield predictions that are in reasonable agreement with each other; in other words, the predictions are only weakly sensitive to the method of representing the intermixing that occurs during the formation of the present multilayer materials.

In another embodiment of this invention, the stochastic model described above is applied to determine reaction properties in rolled Pd/Al LLRCMs. Following the description above, application of the stochastic model requires specification of several physical parameters, including the density, heat capacity, thermal conductivity, and heat of fusion of the reactants and products. Available values from the literature are used for this purpose. Specifically, for the Pd/Al system, we use:

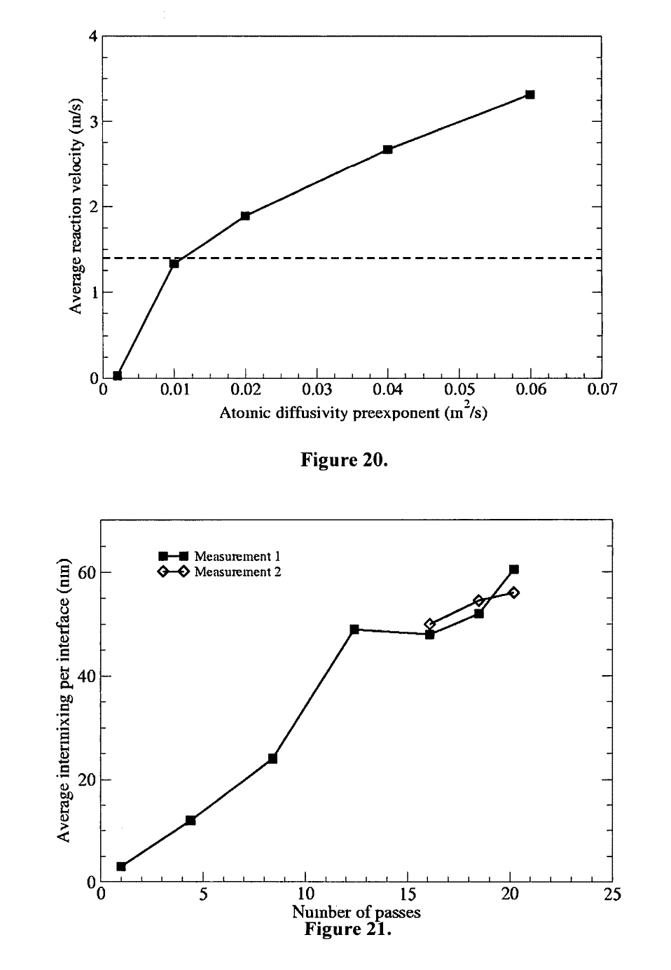

ρ^{Al}=2700 kgm⁻³; ρ^{Pd}=12020 kgm⁻³; Cₚ^{PdAl}=521 Jkg⁻¹ K⁻¹; k^{Al}=204 Wm⁻¹ K⁻¹;
k^{Pd}=71.8 Wm⁻¹ K⁻¹; ΔT_{f}=2647.4K; aw_{Al}=26.98 gmol⁻¹;
M^{Al}=26.98 gmol⁻¹; M^{Pd}=106.42 gmol⁻¹; H_{f}^{Al}=10.7 kJmol⁻¹; H_{f}^{Pd}=16.74 kJmol⁻¹;
H_{f}^{PdAl}=334 kJmol⁻¹; Tₘ^{Al}=933.47K; Tₘ^{Pd}=1825K; Tₘ^{PdAl}=1918K.
In addition to these thermophysical properties, one must also specify values for the pre-exponent, Dₒ, as well as the activation energy, E. The latter is estimated based on DSC results, which yield ε=195.604 Jmol⁻¹. In order to estimate Dₒ, we rely on experimental measurements of the velocity of the self-propagating reaction. As illustrated in FIG. 20, a trial-and-error procedure based on a limited set of measurements is applied to estimate the pre-exponent, which yields Dₒ=0.011 m²/s. This procedure mimics that used to estimate the pre-exponent of vapor-deposited foils¹⁷. It should be evident for someone skilled in the art how to generalize this methodology to a variety of reactive material systems.

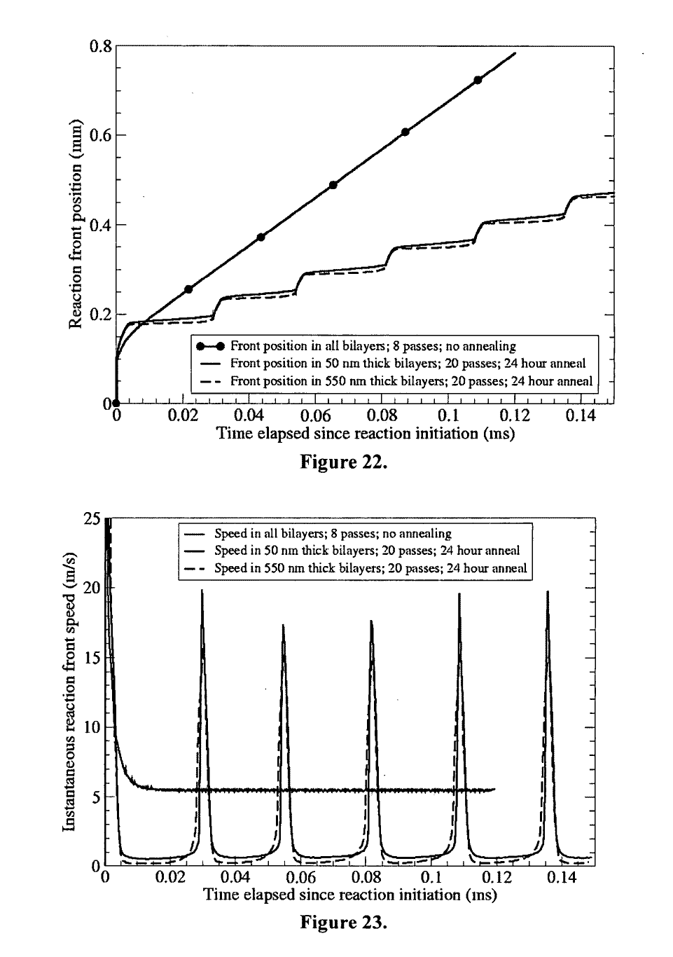

In another embodiment of this invention, the stochastic model is applied to predict the unsteady evolution of the reaction front. The reaction front position is identified by tracking the instantaneous spatial location of the peak source term appearing on the right-hand side of Eq. 5, and is illustrated in FIG. 22.

In another embodiment, the instantaneous reaction front speed is estimated as the local rate of change of the reaction front position, as illustrated in FIG. 23. The average reaction front velocity is determined by averaging the instantaneous speed values over a suitably wide time period. As shown in FIG. 23, the instantaneous speed in some of the modeled foils varies from one bilayer to another, but the averaged reaction velocity is the same in all the bilayers.

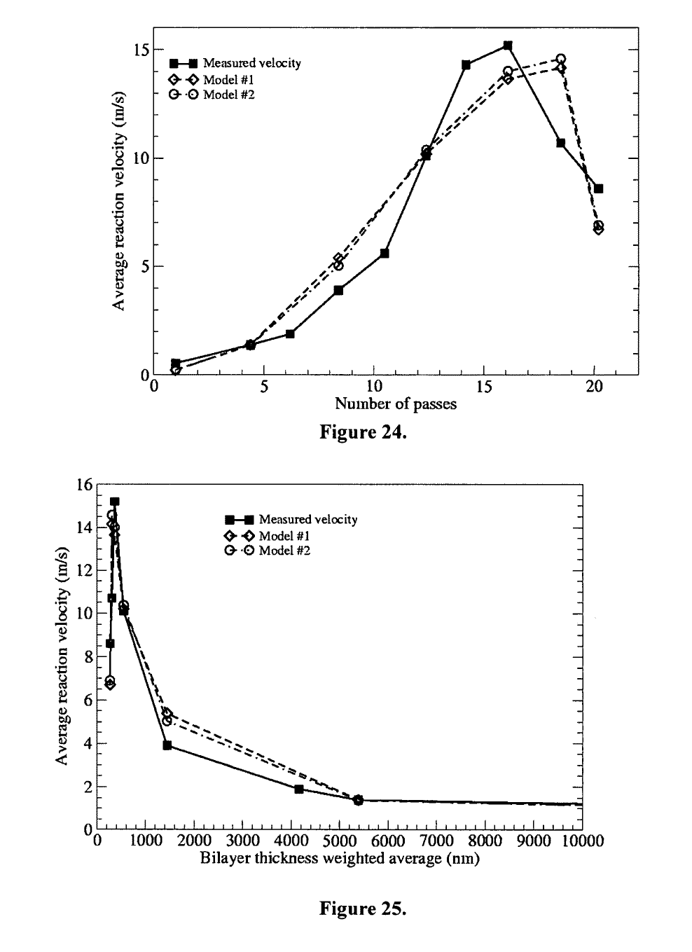

In another embodiment of this invention, the stochastic model is applied to determine the dependence of the reaction velocity in rolled Pd/Al LLRCMs on the number of rolling passes. The results of the computations are shown in FIG. 24, which depicts curves obtained using both Models 1 and 2 as well as measurement results. As shown in FIG. 24, the results for Models 1 and 2 are in close agreement with each other, indicating that the predictions are essentially insensitive to the approach used to estimate and represent the intermixing. Consistent, and in close agreement with experimental measurements, the computed predictions show that as the number of passes increases, the velocity of the self-propagating reactions increases, reaches a well-defined peak, and then decreases. As discussed earlier, this behavior is due to an increase in the amount of deformation-induced intermixing between the reactants, which tends to reduce the reaction heat and velocity.

In another embodiment of this invention, the stochastic model is applied to determine the dependence of the reaction velocity in rolled Pd/Al LLRCMs on the weighted mean bilayer thickness. Plotted in FIG. 25 are curves depicting the variation of the average reaction velocity, V, with the weighted mean bilayer thickness; also shown for comparison are measured values of the reaction velocity. Consistent, and in close agreement with the experimental measurements, the computed predictions indicate that, as the weighted mean bilayer thickness decreases, V initially rises smoothly. This rise is directly attributable to microstructural refinement, which results in enhanced mixing rates. However, as the weighted mean bilayer thickness decreases further, V reaches a peak, and then drops rapidly. As discussed above, and consistent with DSC measurements, this behavior is due to the increase in the amount of deformation-induced intermixing between the reactants. Thus, the velocity of self-propagating reactions in locally-layered reactive composite materials is governed by two competing effects: microstructural refinement—which acts to enhance mixing rates during the reaction and consequently increase the reaction velocity—and deformation-induced intermixing that occurs during processing—which tends to reduce the heat of reaction and the reaction temperature, and consequently reduces the reaction velocity.

In accordance with this invention, mechanically formed LLRCMs have a controlled and selectable self-propagating velocity. Furthermore, in accordance with the embodiments above, the behavior of this selectable self-propagating velocity may be described in terms of a single parameter, namely the weighted mean bilayer thickness. This constitutes a key advantage since, as described earlier, the non-uniform local layering within these materials is characterized by a probability distribution function of bilayer thickness. In other words, the layering may be specified in terms of a functional dependence that involves at least two independent parameters, e.g. a mean value and a standard deviation, variance, or coefficient of variation. Our new-found ability to express the reaction velocity in terms of a single parameter provides a major advantage in various applications where control of heat release rates is needed, including reactive multilayer joining, soldering, brazing, and sealing, as well as use of reactive multilayers as heaters, igniters, or light emitters.

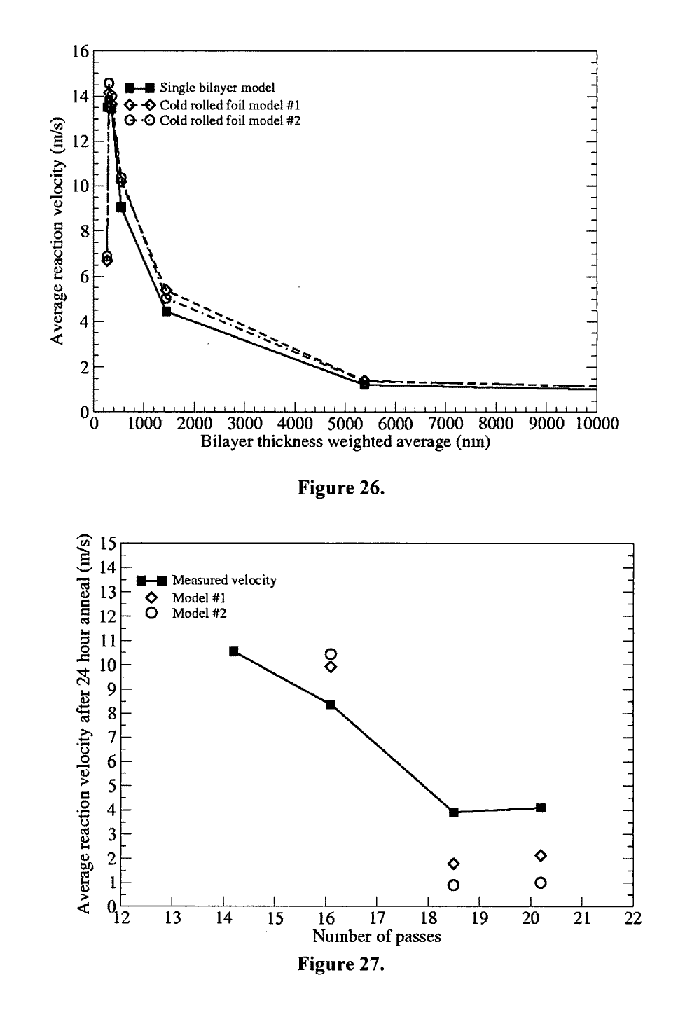

In another embodiment of this invention, the suitability of using the weighted mean bilayer thickness as a means to characterize LLRCMs is further examined through the application of a simplified model based on assuming the bilayer distribution is concentrated at the weighted mean bilayer thickness. In other words, the stochastic computations are run using a single bin that corresponds to the weighted mean bilayer thickness. In the simplified computations, the reaction heat and the thermophysical properties of the reactants and products correspond to those used in the original model above, and the premix width is estimated using Eq. (26). The predictions of the simplified model are shown in FIG. 26. Plotted are curves depicting the dependence of the predicted reaction velocity on the weighted bilayer; also shown for comparison are predictions obtained using Models 1 and 2. As shown in FIG. 26, the predictions of the simplified model are in close agreement with those of the stochastic computations. This gives further support to using the weighted mean bilayer thickness as a means to represent non-uniform or local layering within the present RCMs.

In another embodiment of this invention, the stochastic model is used to determine the effect of annealing on rolled Pd/Al LLRCMs. Predictions are obtained for Pd/Al LLRCMs that were annealed in a furnace for 24 hours at 125° C. The effect of annealing is accounted for in the computations based on the measured reaction heats. As discussed earlier, annealing promotes diffusion and thus intermixing between reactant layers, which consequently reduces the reaction heat within the LLRCM. By measuring the reaction heats using DSC after annealing, new estimates of the intermixing are obtained and then input into the stochastic computations. Plotted in FIG. 27 are curves depicting the dependence of the predicted reaction velocity on the number of passes; also shown for comparison are experimental measurements for the same Pd/Al LLRCMs. Consistent with experimental measurements, the computations indicate that annealing results in a decrease of the reaction velocity. The results also indicate that, though both representations of intermixing yield results that are in good agreement with measurements, the predictions of Model 1 are closer to the measured values; thus, application of Model 1 may be preferable in the present context.

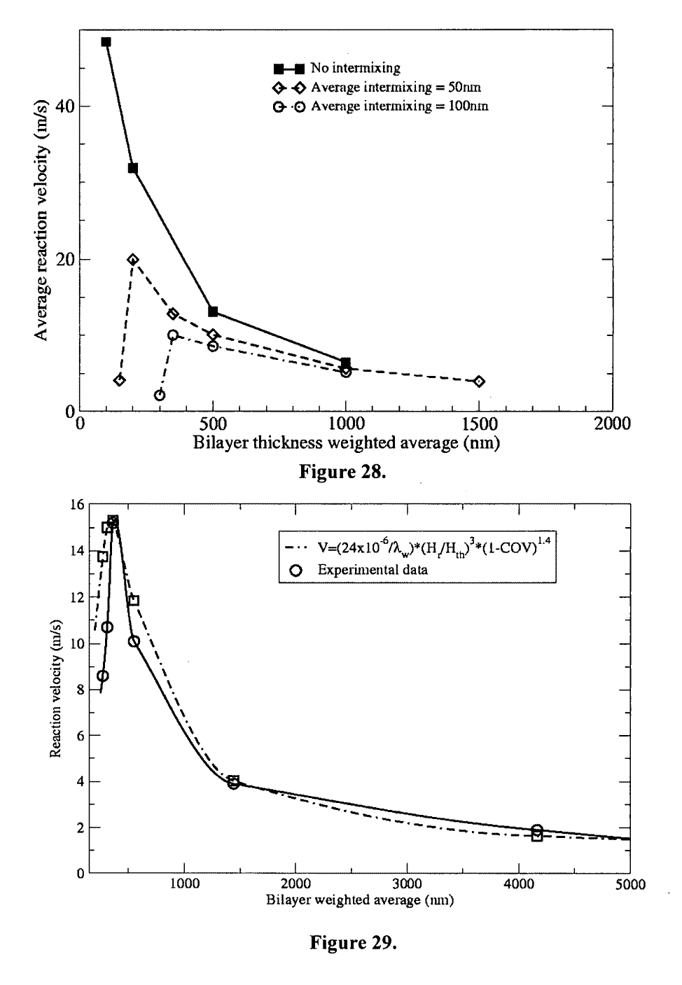

In another embodiment of this invention, the stochastic model is used to estimate the effect of the premix width on the reaction velocity in rolled Pd/Al LLRCMs. Plotted in FIG. 28 is reaction velocity versus weighted mean bilayer thickness; shown are results obtained using Model 1 with premix widths of 100 nm and 50 nm. Also shown in FIG. 28 are predictions obtained for compositionally sharp bilayers, i.e. for vanishingly small premix width. As shown in FIG. 28, when intermixing is ignored, the reaction velocity increases smoothly as the weighted mean bilayer thickness decreases. Thus, proper account of intermixing is essential in order to capture the experimentally observed trends, in particular the presence of a velocity peak and the rapid drop of the reaction velocity to the left of this peak. The results also show that as intermixing increases, the velocity peak moves towards larger bilayer thicknesses, and reaction velocities are generally smaller than those predicted for smaller amounts of intermixing.

In accordance with this invention, locally layered heterogeneous materials are designed that have a selectable self-propagation velocity. In particular, the experimental characterizations and predicted results for the presently-introduced materials can be combined to construct a mathematical correlation that expresses the dependence of the velocity of the self-propagating reaction front on the structure of the material. Specifically, the experimental characterizations and model predictions indicate that the velocity of self-propagating reaction fronts in the present locally-layered RCMs increases as the weighted mean bilayer thickness decreases, and is reduced as the heat of reaction decreases due to intermixing between reactants. This indicates that the self-propagating velocity can be captured using a mathematical correlation of the form:

$$V = \frac{K}{δ} {( \frac{Δ {H}_{rx}}{Δ {H}^{th}} )}^{p} \qquad ( 28 )$$

where K is a dimensional constant (m²/s), δ is a dimensional variable (m) that refers to either the numerical mean or the weighted mean bilayer thickness (respectively δₐᵥ or δ_{w}), ΔHᵣₓ is the actual heat of reaction, and ΔH^{th} is the theoretical heat of reaction that would be obtained using the initial composition assuming no intermixing, and p is an exponent. A more general form of Eq. (28) can also be constructed in order to account for the details of the bilayer distribution, specifically according to:

$$V = \frac{K}{δ} {( \frac{Δ {H}_{rx}}{Δ {H}^{th}} )}^{p} {( 1 - COV )}^{q} \qquad ( 29 )$$

where COV is the coefficient of variation of the PDF describing the bilayer distribution, and q is a second exponent. (The COV is defined as the ratio of the standard deviation to the mean of a given bilayer distribution. It provides a measure of the spread of the PDF. A higher COV value indicates a broader distribution of data. When the PDF is not directly measured, a simplified measure of the spread can be obtained by estimating the ratio R of the largest measured bilayer to the smallest measured bilayer. Thus the condition COV>0.1 may be approximated by the condition that R>1.8.) The above correlations can effectively describe a wide range of material compositions, including systems based on formation or thermite reactions, with K ranging between 10⁻⁶ and 2×10⁻⁴ m²/s, δ ranging between 50×10⁻⁹ m and 50×10⁻⁶ m, p ranging between 1 and 4, and q ranging between 1 and 2. To illustrate this claim, FIG. 29 depicts a best fit for Pd/Al LLRCMs, using Eq. (29) with K=24×10⁻⁶ m²/s, p=3 and q=1.4. As can be observed in FIG. 29, the correlation captures the behavior of the self-propagating velocity, in good agreement with experimental observations and computed predictions.

In accordance with this invention, the rolling process described above can be applied to form composite structures comprising two or more locally-layered RCMs of the type specified above. Such composite structures may comprise two or more locally-layered RCMs having different bilayer distributions, two or more locally-layered RCMs having different compositions, composite structures comprising two or more sputtered deposited RCMs that are laminated by rolling, and composite structures comprising at least one locally-layered RCM and at least one sputter deposited RCM. As discussed in U.S. Pat. No. 6,863,992 to Weihs, et al., advantages of such composite structures include velocity control and cost reduction. For instance, a CuO/Al RCM made by the process of FIG. 30 can be combined with a Pd/Al RCM made by the same process. This may be achieved by stacking the individual multilayers and then rolling the stack to obtain a single composite. The resulting composite carries intrinsic merits in terms of property improvement and cost effectiveness. Specifically, Pd/Al RCMs are expensive but have a low ignition threshold. CuO/Al RCMs are much cheaper but require higher ignition energy and are susceptible to quenching. On the other hand, the Pd—Al/CuO—Al composite is readily ignitable, which ensures that the CuO—Al reaction can be sustained. Thus, the composite can provide both technical advantages and cost savings compared to its individual constituents.

The rolling process described above may also be used to clad an RCM with one or more adhesion layers comprising solder or braze material on one or more surfaces of the RCM. This is a useful advantage in reactive soldering or brazing operations, in which an RCM acts as a local heat source to melt or soften a solder or braze and consequently bond two components that sandwich the RCM. Setup is easier and wetting and thus bonding are more efficient if the solder or braze materials are adhered to the RCM. The cladding process may be used with either mechanically-formed LLRCMs or vapor-deposited RCMs. Cladding of reactive multilayers via rolling may provide substantial cost savings over existing methods, based on vapor deposition of the adhesion layer onto the RCM or vapor depositing the RCM onto the adhesion layer.

It can now be seen that in one aspect the invention is an ignitable, locally layered reactive composite material structure comprising alternating, non-uniform layers of two or more materials that react exothermically along a self-propagating front with a predictable front velocity. Advantageously, the alternating, non-uniform layers can be characterized by a bilayer probability density function whose numerical or weighted mean is within the range from 50 nanometers to 50 micrometers. The predictable front velocity depends on the properties of materials and the bilayer probability density function.

In another aspect, the invention is a method of fabricating a locally-layered ignitable structure comprising the steps of (a) providing an assembly of alternating layers of materials that can exothermically react, (b) performing a deformation of the assembly to reduce its cross section, (c) providing an assembly of two or more layers obtained as a result of the preceding deformation; and (d) repeating steps (b) and (c) a sufficient number of times to produce a non-uniform, locally layered material having a predictable uniform reaction velocity. In an advantageous embodiment layers of a first material can be coated with particles of a second material that can react exothermically with the first.

It is to be understood that the above-described embodiments, examples and aspects of the invention are illustrative of only a few of the many embodiments which can represent applications of the invention. Numerous and varied other structures and processes can be devised by those skilled in the art without departing from the spirit and scope of the invention.

### APPENDIX

¹ T. W. Barbee, Jr, T. P. Weihs, “Ignitable, Heterogeneous, Stratified Structures for the Propagation of Internal, Exothermic, Chemical Reactions along an Expanding Wavefront,” U.S. Pat. No. 5,538,795, Jul. 23, 1996.
² T. P. Weihs, M. Reiss, O. Knio, D. Van Heerden, T. Hufnagel, H. Feldmesser, “Freestanding Reactive Multilayer Foils”, U.S. Pat. No. 6,736,942, May 18, 2004.
³ A. J. Gavens, D. Van Heerden, A. B. Mann, M. E. Reiss, T. P. Weihs, “Effect of Intermixing on Self-Propagating Exothermic Reactions in Al/Ni Nanolaminate Foils,” J. Appl. Phys. 87:1255-1263 (2000).
⁴ H. Sieber, J. S. Park, J. Weissmuller and J. H. Perepezko, Structural Evolution and Phase Formation in Cold-Rolled Aluminum-Nickel Multilayer, Acta Materialia, Vol. 49, pp. 1139-1151, 2001.
⁵ T. P. Weihs and M. Reiss, “Method of Making Reactive Multilayer Foil and Resulting Product,” U.S. Pat. No. 6,534,194, Mar. 18, 2003.
⁶ A. Giguere, N. H. Hai, N. Dempsey and D. Givord, Preparation of Microstructured and Nanostructured Magnetic Materials by Mechanical Deformation, J. of Magnetism and Magnetic Materials, vol. 242-245, 2002, pp. 581-584.
⁷ K. Yasuna, M. Terauchi, A. Otsuki, K. N. Ishihara, P. H. Shingu, Formation of Nanoscale Fe/Al Multilayer by Repeated Press-Rolling and Its Layer Thickness Dependence of Magnetoresistance, Materials Science and Engineering A285, 2000, PP. 412-417.
⁸ L. Battezzati, P. Pappalepore, F. Durbiano and I. Gallino, Solid State Reactions in Al/Ni Alternate Foils Induced by Cold Rolling and Annealing, Acta Materialia, Vol. 47, pp. 1901-1904, 1999.
⁹ R. J. Hebert and J. H. Perepezko, Deformation-Induced Synthesis and Structural Transformations of Metallic Multilayers, Script Materialia, 50, 2004, pp. 807-812.
¹⁰ R. J. Hebert and J. H. Perepezko, Structural Transformations in Crystalline and Amorphous Multilayer Samples During Cold Rolling, Script Materialia, 49, 2003, pp. 933-939.
¹¹ J. H. Perepezko, R. J. Hebert and W. S. Tong, Amorphous and Nanostructure Synthesis in Al Alloys, Intermetallics, 10, 2002, pp. 1079-1088.
¹² N. H. Hai, N. M. Dempsey and D. Givord, Hard Magnetic Fe—Pt Alloys Prepared by Cold-Deformation, J. of Magnetism and Magnetic Materials, vol. 262-245, 2003, pp. 353-360.
¹³ F. H. Kavarana, K. S. Ravichandran and S. S. Sahay, Nanoscale Steel-Brass Multilayer Laminates Made by Cold Rolling: Microstructure and Tensile Properties, Scripta Materialia, 42, 2000, pp. 947-954.
¹⁴ P. H. Shingu, K. N. Ishihara, A. Otsuki and I. Daigo, Nano-Scale Multilayer Bulk Materials Manufactured by Repeated Pressing and Rolling in the Cu—Fe System, Materials Science and Engineering A304-306, 2001, PP. 399-402.
¹⁵ S. Kikuchi, H. Kuwahara, N. Mazaki, S. Urai and H. Miyamura, Mechanical Properties of Ag−Ni Super-Laminates Produced by Rolling, Materials Science and Engineering A234-236, 1997, PP. 1114-1117.
¹⁶ E. Besnoin, S. Cerutti, O. M. Knio, T. P. Weihs, “Effect of Reactant and Product Melting on Self-Propagating Reactions in Multilayer Foils,” J. Appl. Phys. 92:5474-5481 (2002).
¹⁷ A. B. Mann, A. J. Gavens, M. E. Reiss, D. Van Heerden, G. Bao, T. P. Weihs, J. of Applied Physics, 82, pp. 1178-1188, 1997.
¹⁸ R. Hultgren, R. Orr, P. Anderson, K. Kelley, Selected Values of Thermodynamic Properties of Metals and Alloys, Wiley, NY, 1963.

What is claimed is:

1. An ignitable locally layered reactive composite material comprising alternating non-uniform layers of two or more materials that react exothermically along a self-propagating front with a predictable front velocity V.

2. The locally layered reactive composite material of claim 1 wherein the alternating non-uniform layers can be characterized by a bilayer probability density function whose numerical or weighted mean, δ, is within the range from 50 nanometers to 50 micrometers.

3. The locally layered reactive composite material of claim 2 wherein the predictable front velocity V depends on the properties of the materials and the bilayer probability density function.

4. The locally layered reactive composite material of claim 3 wherein the front velocity V can be mathematically expressed as:
$$V = \frac{K}{δ} {( \frac{Δ {H}_{rx}}{Δ {H}^{th}} )}^{p} {( 1 - COV )}^{q}$$
where K is a composition-dependent dimensional constant that ranges between 10⁻⁶ and 2×10⁻⁴ m²/s, ΔHᵣₓ is the actual heat of reaction, and ΔH^{th} is the theoretical heat of reaction that would be obtained assuming no intermixing at the interfaces between otherwise chemically-distinct layers, p is a first exponent in the range 1-4, and q is a second exponent in the range 1-2.

5. The locally layered reactive composite material of claim 3 wherein the front velocity V can be mathematically expressed as:
$$V = \frac{K}{δ} {( \frac{Δ {H}_{rx}}{Δ {H}^{th}} )}^{p}$$
where K is a composition-dependent dimensional constant that ranges between 10⁻⁶ and 2×10⁻⁴ m²/s, ΔHᵣₓ is the actual heat of reaction, and ΔH^{th} is the theoretical heat of reaction that would be obtained assuming no intermixing at the interfaces between otherwise chemically-distinct layers, and p is an exponent in the range 1-4.

6. The locally layered reactive composite material of claim 1 wherein the materials that react exothermically react to form an aluminide.

7. The locally layered reactive composite material of claim 1 wherein one of the materials that reacts exothermically comprises aluminum and another of the materials that react comprises a material selected from the group consisting of Ni, Monel, Ti, Zr, and Pd.

8. The locally layered reactive composite material of claim 1 wherein the materials that react exothermically react to form a silicide.

9. The locally layered reactive composite material of claim 1 wherein one of the materials that react comprises silicon and another of the materials that react comprises a material selected from the group consisting of Ti, Nb and Zr.

10. The locally layered reactive composite material of claim 1 wherein one of the materials that react exothermically comprises carbon and another of the materials that react comprises a material selected from the group consisting of Ti, Zr and Hf.

11. The locally layered reactive composite material of claim 1 wherein the materials that react exothermically react to form a boride.

12. The locally layered reactive composite material of claim 1 wherein one of the materials that react exothermically comprises boron and another of the materials that react comprises a material selected from the group consisting of Ti, Zr, and Hf.

13. The locally layered reactive composite material of claim 1 wherein the materials that react exothermically react in a thermite reaction.

14. The locally layered reactive composite material of claim 1 wherein one of the materials that react exothermically comprises aluminum and another of the materials that react comprises an oxide.

15. The locally layered reactive composite material of claim 1 wherein the material is in the form of a sheet.

16. The locally layered reactive composite material of claim 1 wherein the material is in the form of a wire or rod.

17. A structure comprising a locally layered reactive composite material according to claim 1 clad with a layer of solder or braze.

18. A laminate structure comprising two or more locally layered reactive composite materials according to claim 1 laminated together.

19. A method of fabricating an ignitable locally-layered composite material comprising the steps of:
a. providing an assembly of alternating layers of materials that can exothermically react;
b. performing a deformation of the assembly to reduce its cross-section;
c. providing an assembly of two or more layers obtained as a result of the preceding deformation; and
d. repeating steps b and c a sufficient number of times to produce a non-uniform, locally layered material having a predictable uniform reaction velocity.

20. The method of claim 19 wherein the assembly of alternating layers comprises a stack of foil.

21. The method of claim 19 wherein deforming the assembly comprises rolling.

22. The method of claim 21 wherein the rolling strain rate ranges between 10⁻² and 1 s⁻¹.

23. The method of claim 19 wherein deforming the assembly comprises sheath rolling, warm rolling, swaging, extrusion, or hot pressing.

24. The method of claim 19 wherein the first deformation reduces the cross-section by 50% or more.

25. The method of claim 19 further including one or more edge-trimming steps between deformation steps.

26. The method of claim 19 further comprising one or more annealing steps between deformation steps.

27. The method of claim 26 wherein the annealing is performed in an inert atmosphere.

28. The method of claim 26 wherein the annealing is performed at a temperature of about 150° C. or less.

29. The method of claim 19 wherein the initial assembly has width-to-thickness ratio of about 200:1 or larger.

30. The method of claim 19 wherein the initial assembly has 5 or more bilayers.

31. The method of claim 19 wherein the materials in the assembly have a hardness ratio of about 1.5:1 or smaller.

32. The method of claim 19 wherein the assembly is maintained at a temperature below about 100° C. during deformation.

33. The method of claim 19 wherein cutting of one deformed assembly is performed to obtain two or more layers for subsequent stacking and deformation.

34. The method of claim 19 wherein one or more of the assemblies further comprises one or more layers of joining material.

35. The method of claim 19 wherein adjacent layers of reactants in the initial assembly are separated by a barrier layer of an inert material.

36. The method of claim 35 wherein the barrier material is a metal or a joining material.

37. The method of claim 19 wherein sufficient deformation steps are applied so that the resulting material is substantially free of distinct islands of reactants.

38. A product made by the process of claim 19.

39. A method of fabricating an ignitable locally-layered composite material comprising the steps of:
a. providing an assembly of layers of one material that are coated with particles of a second material that can exothermically react with the first;
b. performing a deformation of the assembly to reduce its cross-section;
c. providing an assembly of two or more layers obtained as a result of the preceding deformation; and
d. repeating steps b and c a sufficient number of times to produce a non-uniform, locally layered material having a predictable uniform reaction velocity.

40. The method of claim 39 wherein the assembly of alternating layers comprises a stack of foil.

41. The method of claim 39 wherein deforming the assembly comprises rolling.

42. The method of claim 41 wherein the rolling strain rate ranges between 10⁻² and 1 s⁻¹.

43. The method of claim 39 wherein deforming the assembly comprises sheath rolling, warm rolling, swaging, extrusion, or hot pressing.

44. The method of claim 39 wherein the first deformation reduces the cross-section by 50% or more.

45. The method of claim 39 further including one or more edge-trimming steps between deformation.

46. The method of claim 39 further comprising one or more annealing steps between deformation.

47. The method of claim 46 wherein the annealing is performed in an inert atmosphere.

48. The method of claim 46 wherein the annealing is performed at a temperature of about 150° C. or less.

49. The method of claim 39 wherein the initial assembly has width-to-thickness ratio of about 200:1 or larger.

50. The method of claim 39 wherein the initial assembly has 5 or more coated layers.

51. The method of claim 39 wherein the assembly is maintained at a temperature below about 100° C. during deformation.

52. The method of claim 39 wherein cutting of one deformed assembly is performed to obtain two or more layers for subsequent stacking and deformation.

53. The method of claim 39 wherein the one or more of the assemblies further comprises one or more layers of joining material.

54. The method of claim 39 wherein the one or more assemblies further includes a diluent.

55. The method of claim 54 wherein the diluent is a metal or a joining material.

56. The method of claim 39 wherein sufficient deformation steps are applied so that the resulting material is substantially free of distinct islands of reactants.

57. A product made by the process of claim 39.

58. The locally layered reactive composite material of claim 1 wherein one of the materials that react exothermically comprises a material selected from the group consisting of Al, Ti, Zr, Mg, and Hf and another of the materials that react comprises a carbide.
